(19) United States
(12) Patent Application Publication
(10) Pub. No.: US 2026/0254807 A1
(43) Pub. Date: Aug. 27, 2026

(54) DEVICE CREDENTIAL MIGRATION

(71) Applicant: Apple Inc., Cupertino, CA (US)

(72) Inventors: Sunil Nair, Fremont, CA (US); Alexander D. Pelletier, Sunnyvale, CA (US); Rahul Narayan Singh, Santa Clara, CA (US); Eric T. York, Cupertino, CA (US); Paul Boulay, Menlo Park, CA (US); Robin Burel, Santa Clara, CA (US); Venkata S. Akella, San Ramon, CA (US)

(73) Assignee: Apple Inc., Cupertino, CA (US)

(21) Appl. No.: 19/427,904

(22) Filed: Dec. 19, 2025

Related U.S. Application Data
(60) Provisional application No. 63/761,815, filed on Feb. 21, 2025.

(51) Int. Cl. H04L 9/40

(52) U.S. Cl. CPC H04L 63/083; H04L 63/0823

(57) ABSTRACT

The present application relates to devices and components including apparatus, systems, and methods to migrate one or more credentials from a first device to a second device. The migration of the one or more credentials can include performing authentication procedures corresponding to the one or more credentials for determining whether migration of the one or more credentials is allowable, and utilizing certificate authority security domains of secure elements to bind the one or more credentials to the secure elements for migration.

### CROSS-REFERENCE TO RELATED APPLICATIONS

This application claims the benefit of, and priority to, U.S. provisional application No. 63/761,815, entitled “Device Credential Migration,” filed on Feb. 21, 2025, the disclosure of which is incorporated by reference herein in its entirety for all purposes.

### BACKGROUND

With the continued development and improvement of devices, applications have developed for the devices that allow the user them to handle more tasks. Applications have developed to manage credentials of a user of a device and facilitate the use of the credentials by the user for performing tasks. The device may store information for the credentials and prevent other devices from accessing the information. As the information for the credentials can be highly confidential, high levels of security and verification is often implemented for initially provisioning the information to the device.

### BRIEF DESCRIPTION OF THE DRAWINGS

FIG. 1 illustrates a first part of an example credential migration procedure representation showing a first portion of elements in accordance with some embodiments.

FIG. 2 illustrates the first part of the example credential migration procedure representation showing a second portion of elements in accordance with some embodiments.

FIG. 3 illustrates a second part of the example credential migration procedure representation showing the first portion of the elements in accordance with some embodiments.

FIG. 4 illustrates the second part of the example credential migration procedure representation showing the second portion of the elements in accordance with some embodiments.

FIG. 5 illustrates a third part of the example credential migration procedure representation showing the first portion of the elements in accordance with some embodiments.

FIG. 6 illustrates the third part of the example credential migration procedure representation showing the second portion of the elements in accordance with some embodiments.

FIG. 7 illustrates a fourth part of the example credential migration procedure representation showing the first portion of the elements in accordance with some embodiments.

FIG. 8 illustrates the fourth part of the example credential migration procedure representation showing the second portion of the elements in accordance with some embodiments.

FIG. 9 illustrates a fifth part of the example credential migration procedure representation showing the first portion of the elements in accordance with some embodiments.

FIG. 10 illustrates the fifth part of the example credential migration procedure representation showing the second portion of the elements in accordance with some embodiments.

FIG. 11 illustrates a sixth part of the example credential migration procedure representation showing the first portion of the elements in accordance with some embodiments.

FIG. 12 illustrates the sixth part of the example credential migration procedure representation showing the second portion of the elements in accordance with some embodiments.

FIG. 13 illustrates a seventh part of the example credential migration procedure representation showing the first portion of the elements in accordance with some embodiments.

FIG. 14 illustrates the seventh part of the example credential migration procedure representation showing the second portion of the elements in accordance with some embodiments.

FIG. 15 illustrates an eighth part of the example credential migration procedure representation showing the first portion of the elements in accordance with some embodiments.

FIG. 16 illustrates the eighth part of the example credential migration procedure representation showing the second portion of the elements in accordance with some embodiments.

FIG. 17 illustrates a ninth part of the example credential migration procedure representation showing the first portion of the elements in accordance with some embodiments.

FIG. 18 illustrates the ninth part of the example credential migration procedure representation showing the second portion of the elements in accordance with some embodiments.

FIG. 19 illustrates a tenth part of the example credential migration procedure representation showing the first portion of the elements in accordance with some embodiments.

FIG. 20 illustrates the tenth part of the example credential migration procedure representation showing the second portion of the elements in accordance with some embodiments.

FIG. 21 illustrates an eleventh part of the example credential migration procedure representation showing the first portion of the elements in accordance with some embodiments.

FIG. 22 illustrates the eleventh part of the example credential migration procedure representation showing the second portion of the elements in accordance with some embodiments.

FIG. 23 illustrates a block diagram of an example user device in accordance with some embodiments.

FIG. 24 illustrates an example procedure for migrating one or more credentials in accordance with some embodiments.

FIG. 25 illustrates an example procedure for provisioning one or more credentials in accordance with some embodiments.

FIG. 26 illustrates an example procedure for migrating one or more credentials in accordance with some embodiments.

FIG. 27 illustrates an example architecture or environment configured to implement techniques described herein in accordance with some embodiments.

FIG. 28 is a block diagram of an example computing device that can implement the features and processes described throughout this disclosure in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail.

Applications have been developed on user devices to manage credentials for users. The process of adding credentials to a user device can include performing user verification for each credential to be added as well as any other security measures required by a credential issuer and/or manager. At times, a user may obtain a new user device and want to have credentials added to applications on the new user device. In legacy instances, the user would need to repeat the process of individually adding the credentials to the new user device, along with performing the verifications and other security measures for adding the credentials. The process of individually adding the credentials to the new device can be time consuming and can tie up resources that could be utilized for other operations.

Approaches described herein may facilitate migration of credentials from one user device to another user device. In particular, the approaches may facilitate communications between a first user device and a second user device for migrating one or more credentials from the first user device to the second user device. One of the user devices can present a selection of credentials that can be migrated from the first user device to the second user device. The user may select one or more of credentials to be migrated from the first user device to the second user device. The user device may establish a channel with the other user device for migrating the selected one or more credentials between the user devices. In some instances, multiple credentials can require a same verification procedure and/or other security procedure. The device can identify verification procedures and/or security procedures being performed for multiple devices and can coalesce the procedures such that each verification procedure and/or security procedure is performed a single time for all of the credentials rather than being performed multiple times for the credentials. The approaches described herein, including the coalescing of procedures, can reduce the time and use of resources for adding credentials to the user device.

As an example, a user may own a first device with one or more accounts being managed by applications on the first device. The user may decide to obtain a new second device to replace the first device. As part of the transition to the new second device, the user may want to migrate the one or more accounts to the new second device. The user may sign into the second device with a user account that is associated with the first device and request the one or more accounts be migrated to the second device. The second device may determine verification procedures and/or security procedures to be performed for migrating the accounts and may perform the procedures. Based on the verification procedures and/or security procedures being successful, the accounts can be migrated from the first device to the second device. After the accounts have been migrated, the accounts may be stored on the second device and may be removed from the first device. The user can then utilize the second device to perform operations with the accounts.

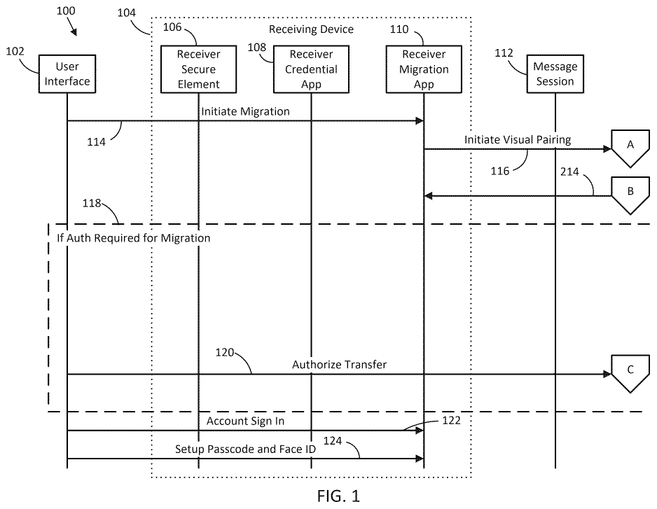

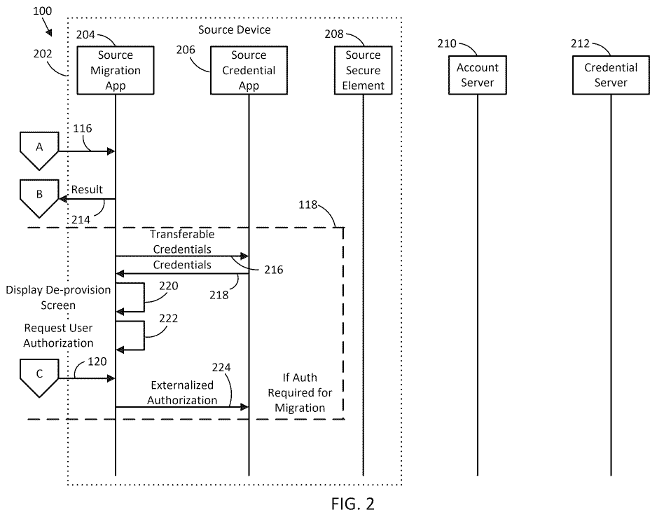

FIG. 1 illustrates a first part of an example credential migration procedure representation 100 showing a first portion of elements in accordance with some embodiments. FIG. 2 illustrates the first part of the example credential migration procedure representation 100 showing a second portion of elements in accordance with some embodiments. The credential migration procedure representation 100 illustrates an example procedure for migrating one or more credentials from a source device to a receiving device.

The credential migration procedure representation 100 includes a user interface 102. The user interface 102 may include one or more interfaces with which devices (such as a receiving device 104 and/or a source device 202) may interact an individual and/or entity that owns a user account, where the user account can be associated with devices.

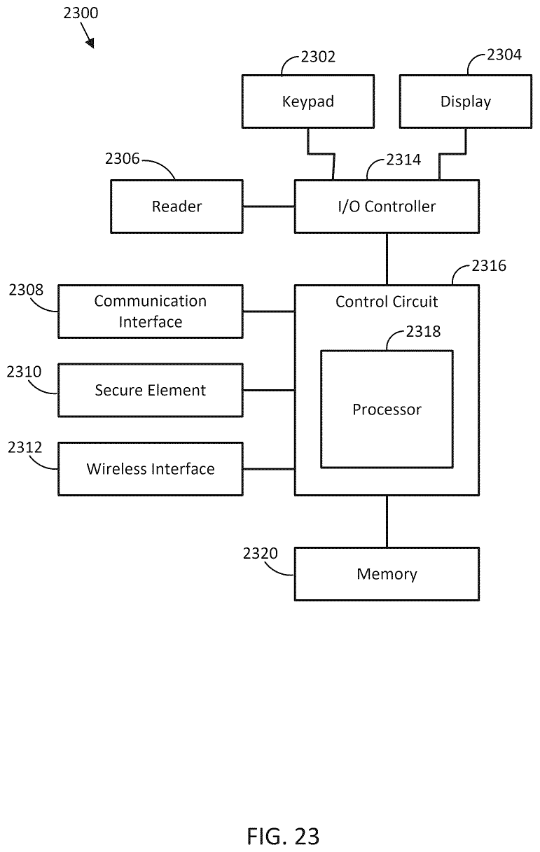

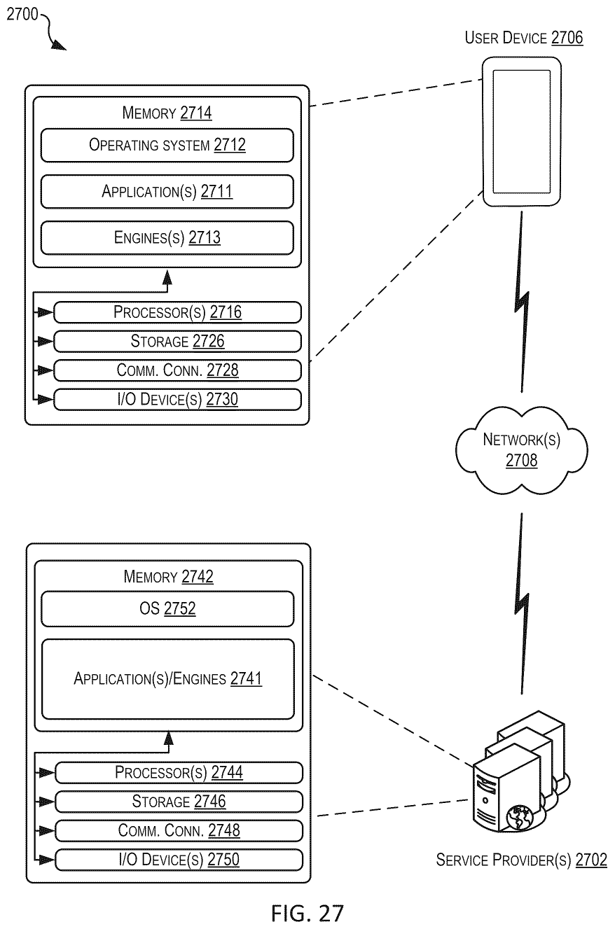

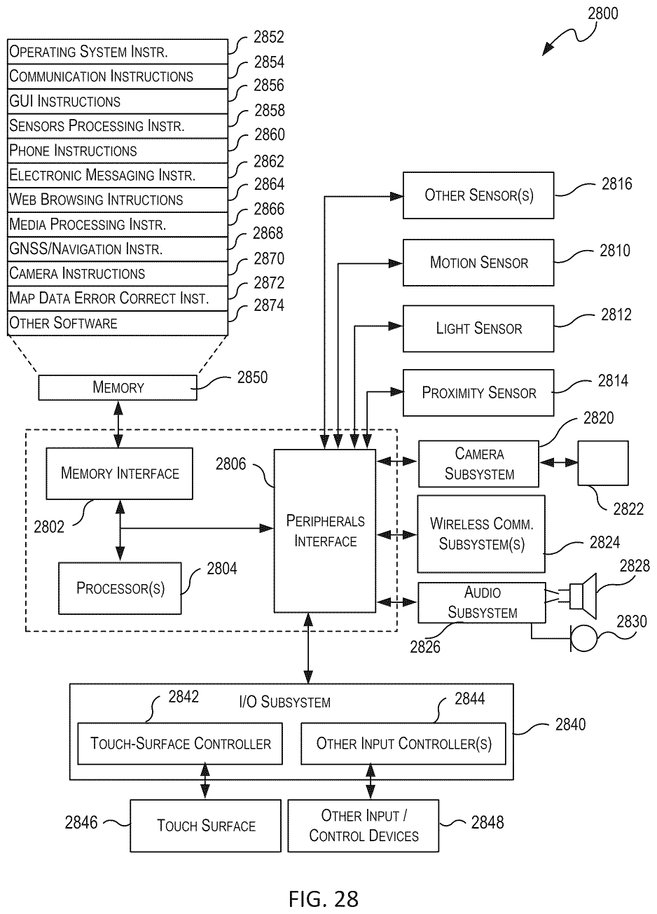

The credential migration procedure representation 100 includes a receiving device 104. The receiving device 104 may include one or more of the features of the user device 2300 (FIG. 23), the user device 2706 (FIG. 27), and/or the computing device 2800 (FIG. 28). The receiving device 104 may be associated with the user account of a user. For example, the user may utilize the user account to access the receiving device 104 and/or utilize services of the receiving device 104.

The receiving device 104 may include a receiver secure element 106. The receiver secure element 106 may include one or more of the features of the secure element 2310 (FIG. 23). The receiver secure element 106 may be a hardware device implemented within the receiving device 104 that can store confidential information related to credentials and/or can perform operations with the confidential information. The receiver secure element 106 may be manufactured with security features that limit access to the receiver secure element 106 and/or services provided by the receiver secure element 106. For example, the receiver secure element 106 may be manufactured with keys and/or other encryption elements assigned to the receiver secure element 106 at manufacturing. The keys and/or other encryption elements may be utilized to access the receiver secure element 106 and/or the services provided by the receiver secure element 106. Limited elements may be provided the keys and/or other encryption elements, thereby limiting access to the receiver secure element 106 and/or the services provided by the receiver secure element 106.

The receiving device 104 may include a receiver credential application 108. The receiver credential application 108 may include instructions that, when executed by one or more processors of the receiving device 104, can cause the receiving device 104 to perform operations, including operations described as being performed by the receiver credential application 108 throughout this disclosure. The receiver credential application 108 may manage credentials on the receiving device 104.

The receiving device 104 may include a receiver migration application 110. The receiver migration application 110 may include instructions, that when executed by one or more processors of the receiving device 104, can cause the receiving device 104 to perform operations, including operations described as being performed by the receiver migration application 110 throughout this disclosure. The receiver migration application 110 may facilitate migration of data between the receiving device 104 and other devices.

The credential migration procedure representation 100 includes a message session 112. The message session 112 may be established for exchanging messages between devices. Applications on the devices may facilitate establishment of the message session 112. In some embodiments, the message session 112 may be secure with messages transmitted via the message session 112 being encrypted for security.

The credential migration procedure representation 100 includes a source device 202. The source device 202 may include one or more of the features of the user device 2300 (FIG. 23), the user device 2706 (FIG. 27), and/or the computing device 2800 (FIG. 28). The source device 202 may be associated with the user account of the user. For example, the user may utilize the user account to access the source device 202 and/or utilize services of the source device 202.

The source device 202 may include a source migration application 204. The source migration application 204 may be a same application as the receiver migration application 110, although implemented on the source device 202 rather than the receiving device 104. The source migration application 204 may include instructions, that when executed by one or more processors of the source device 202, can cause the source device 202 to perform operations, including operations described as being performed by the source migration application 204 throughout this disclosure. The source migration application 204 may facilitate migration of data between the source device 202 and other devices. In the illustrated embodiment, the source migration application 204 may facilitate migration of data, including credentials, between the source device 202 and the receiving device 104. The source migration application 204 may communicate with the receiver migration application 110 via the message session 112 to facilitate the transfer of data.

The source device 202 may include a source credential application 206. The source credential application 206 may be a same application as the receiver credential application 108, although implemented on the source device 202 rather than the receiving device 104. The source credential application 206 may include instructions that, when executed by one or more processors of the source device 202, can cause the source device 202 to perform operations, including operations described as being performed by the source credential application 206 throughout this disclosure. The source credential application 206 may manage credentials on the source device 202.

The source device 202 may include a source secure element 208. The source secure element 208 may include one or more of the features of the secure element 2310 (FIG. 23). The source secure element 208 may be a hardware device implemented within the source device 202 that can store confidential information related to credentials and/or can perform operations with the confidential information. The source secure element 208 may be manufactured with security features that limit access to the source secure element 208 and/or services provided by the source secure element 208. For example, the source secure element 208 may be manufactured with keys and/or other encryption elements assigned to the source secure element 208 at manufacturing. The keys and/or other encryption elements may be utilized to access the source secure element 208 and/or the services provided by the source secure element 208. Limited elements may be provided the keys and/or other encryption elements, thereby limiting access to the source secure element 208 and/or the services provided by the source secure element 208.

The credential migration procedure representation 100 includes an account server 210. The account server 210 may include one or more computing and/or storage devices that can store and process data related to user devices, such as the receiving device 104 and the source device 202. For example, the account server 210 may store information for user accounts (such as the user account for the user) and can utilize the information for determining users authorizations to access the user accounts and/or the user devices associated with the user accounts. In the illustrated embodiment, the account server 210 may manage a user account for the user, and can provide services for the receiving device 104 and the source device 202, including determining whether the user is authorized to access the user devices and/or determining services that the user may utilize with the user devices.

The credential migration procedure representation 100 includes a credential server 212. The credential server 212 may include one or more computing and/or storage devices that can store and process data related to credentials that can be managed by the receiving device 104 and the source device 202. In some embodiments, the credential server 212 can facilitate the provisioning of credentials to user devices, such as the receiving device 104 and the source device 202. The credential server 212 may be maintained by a third party that generates and/or manages the credentials.

The user may, via the user interface 102, initiate a migration of credentials in 114. For example, the receiver migration application 110 may cause the receiving device 104 to display a graphical user interface that provides the option of initiating the migration of credentials. The user may interact with the receiving device 104, via the user interface 102, to indicate that the user would like to initiate the migration of credentials. The receiver migration application 110 may identify the indication, from the user interface 102, to initiate the migration of credentials.

Based on the receiver migration application 110 identifying the indication to initiate the migration of credentials, the receiver migration application 110 may initiate a visual pairing with the source migration application 204 in 116. For example, the receiver migration application 110 may cause the receiving device 104 to detect other devices within a proximity of the receiving device 104 for pairing, such as by using near field communication (NFC) for detecting other devices within the proximity. In some embodiments, the user may interact, via the user interface 102, with the source device 202 to cause the source device 202 to await a visual pairing request from the receiving device 104. The receiver migration application 110 may cause the receiving device 104 to generate and transmit a visual pairing request to one or more devices detected within the proximity.

The source migration application 204 may identify the visual pairing request received from the receiver migration application 110. For example, the source device 202 may receive (such as via NFC) the visual pairing request transmitted from the receiving device 104 and the source migration application 204 may identify the received visual pairing request. The source migration application 204 may determine whether a visual pairing is to be established with the receiver migration application 110. If the source migration application 204 determines that the visual pairing is to be established, the source migration application 204 may establish the visual pairing with the receiver migration application 110. The source migration application 204 may generate and transmit to the receiver migration application 110 an indication of the visual pairing result in 214. The indication may indicate whether the visual pairing was successful.

The credential migration procedure representation 100 may include an authorization procedure 118 if authorization is required for migration. The authorization procedure 118 may be omitted if authorization is not required for migration.

The authorization procedure 118 may include the source migration application 204 requesting transferable credentials from the source credential application 206 in 216. For example, the source migration application 204 may generate and transmit a transferable credential request to the source credential application 206. The transferable credential request may request an indication of credentials available for migration to the receiving device 104.

The source credential application 206 may identify the transferable credential request received from the source migration application 204. The authorization procedure 118 may include the source credential application 206 identifying credentials managed by the source credential application 206 that are available for migration to the receiving device 104. In some instances, the source credential application 206 may identify one or more credentials managed by the source credential application 206 and determine that the one or more credentials are migratable to the receiving device 104. In other instances, the credentials managed by the source credential application 206 may have corresponding indications that indicate whether the credential is migratable. The source credential application 206 may identify which managed credentials are migratable and may determine that one or more credentials are migratable based on the indications. The source credential application 206 may generate and transmit an indication to the source migration application 204 in 218, the indication indicating the one or more credentials available for migration to the receiving device 104.

The source migration application 204 may identify the indication of the one or more credentials received from the source credential application 206. The source migration application 204 may cause the source device 202 to display a de-provision screen in 220. The de-provision screen may display the one or more credentials available for migration to the receiving device 104 and provide the user with the option to select credentials from the one or more credentials to be migrated. The user may be able to select, via the user interface 102, credentials for migration.

The source migration application 204 may initiate a request or user authorization for the migration in 222. For example, the source migration application 204 may display a graphical user interface requesting the user to perform a procedure for authorization. The graphical user interface may be displayed as part of the de-provision screen. In some embodiments, the source migration application 204 may request that the user input a passcode, perform a biometric recognition procedure (such as facial or fingerprint recognition procedures), or perform another authorization procedure in the graphical user interface.

The user may authorize the transfer (i.e., migration) in 120. For example, the user may complete, via the user interface 102, the requested authorization procedure from 222 to indicate that the migration of the credentials is authorized.

The source migration application 204 may identify the authorization of the transfer from the user. As part of the authorization procedure 118, the source migration application 204 may generate and transmit an externalized authorization indication to the source credential application 206 in 224. The externalized authorization indication may indicate whether the user has successfully completed the requested authorization procedure. The source credential application 206 may determine whether the migration of the credentials is authorized based on the externalized authorization indication. The authorization procedure 118 may terminate after 224.

The user may perform, via the user interface 102, an account sign in with the receiver migration application 110 in 122. For example, the receiver migration application 110 may cause the receiving device 104 to display a sign in graphical user interface. The user may interact, via the user interface 102, with the sign in graphical user interface to present information for signing in to the receiver migration application. In some embodiments, the information for signing in may include a username and/or a passcode corresponding to an account of the user. The receiver migration application 110 may detect the input of the information for signing in and may verify that the user is authorized to sign in to the receiver migration application 110. If the receiver migration application 110 determines that the user is not authorized to sign in, the procedure of the credential migration procedure representation 100 may terminate. If the receiver migration application 110 determines that the user is authorized to sign in, the procedure may proceed.

The user may set up, via the user interface 102, further authentication procedures with the receiver migration application 110 in 124. For example, the receiver migration application 110 may cause the receiving device 104 to display a graphical user interface to set up further authentication procedures. The user may interact, via the user interface 102, with the graphical user interface to setup the further authentication procedures. The receiver migration application 110 may identify the inputs and utilize the inputs for future authentication of the user.

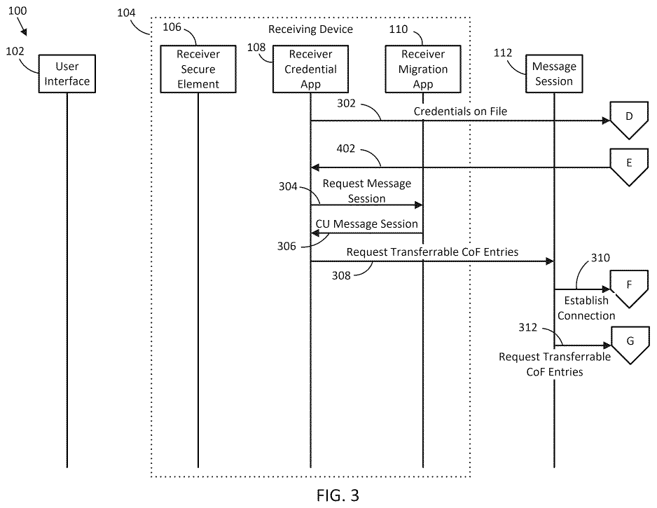

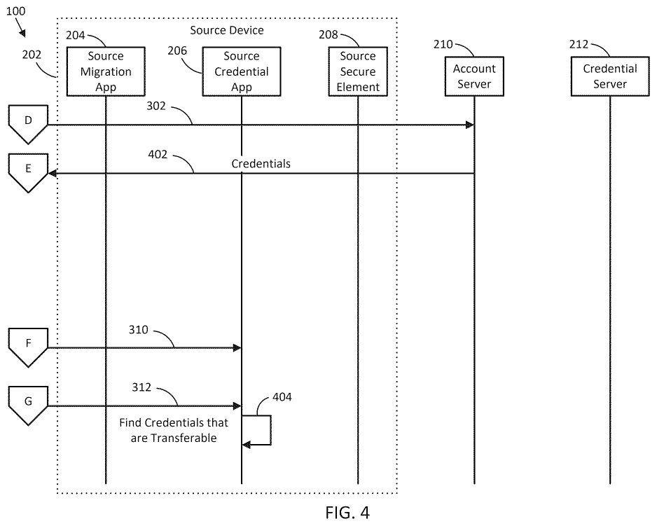

FIG. 3 illustrates a second part of the example credential migration procedure representation 100 showing the first portion of the elements in accordance with some embodiments. FIG. 4 illustrates the second part of the example credential migration procedure representation 100 showing the second portion of the elements in accordance with some embodiments.

The receiver credential application 108 may generate and transmit a credentials on file request to the account server 210 in 302. The credentials on file request may request an indication of the credentials associated with the account of the user maintained by the account server 210.

The account server 210 may identify the credentials on file request. The account server 210 may identify the credentials associated with the account of the user. The account server 210 may generate and transmit an indication of the identified credentials in 402.

The receiver credential application 108 may identify the indication of the identified credentials. The receiver credential application 108 may generate and transmit a request message session request to the receiver migration application 110 in 304. The request message session request may indicate that a message session is requested to be established between the receiving device 104 and the source device 202.

The receiver migration application 110 may identify the request message session request. The receiver migration application 110 may respond to the receiver credential application 108 with a message session transmission in 306. For example, the receiver migration application 110 may generate and transmit a message session transmission in 306, where the message session transmission may include information for establishing a message session between the receiving device 104 and the source device 202.

The receiver credential application 108 may identify the message session transmission. The receiver credential application 108 may request transferable credentials on file (CoF) entries in 308. For example, the receiver credential application 108 may generate and transmit a transferable CoF entries request to the message session 112.

The message session 112 may identify the transferable CoF entries request received from the receiver credential application 108. The message session 112 may establish a connection with the source credential application 206 in 310. In some embodiments, the message session 112 may establish a secure connection, such as by exchanging keys or encryption elements for encrypting transmissions for the message session 112.

Once the connection has been established, the message session 112 may forward the transferrable CoF entries request to the source credential application in 312. For example, the message session 112 may forward the transferable CoF entries request received in 308.

The source credential application 206 may identify the transferable CoF entries request. The source credential application 206 may identify credentials in 404. For example, the source credential application 206 may identify credentials maintained on the source device 202.

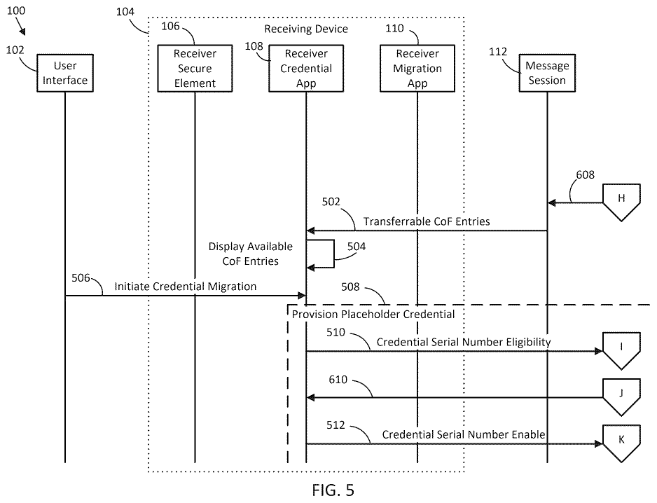

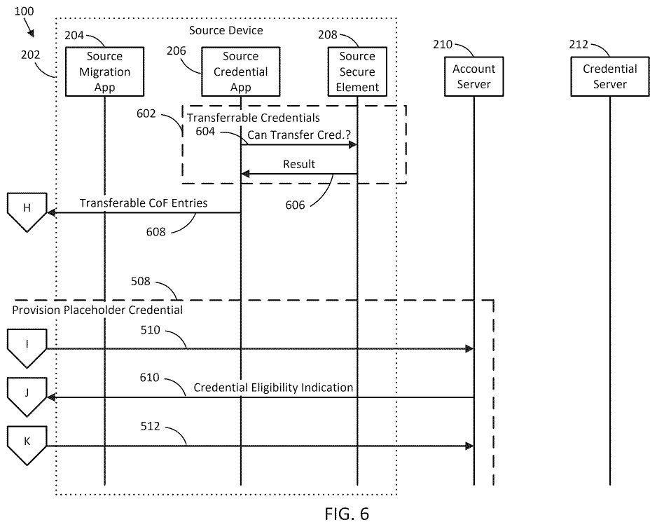

FIG. 5 illustrates a third part of the example credential migration procedure representation 100 showing the first portion of the elements in accordance with some embodiments. FIG. 6 illustrates the third part of the example credential migration procedure representation 100 showing the second portion of the elements in accordance with some embodiments.

The procedure represented in the credential migration procedure representation 100 may include a transferable credentials procedure 602. For example, a transferrable credentials procedure 602 may be initiated by the source credential application 206 based on the source credential application 206 identifying the credentials. The source credential application 206 may generate and transmit a transfer credential inquiry to the source secure element 208 in 604. The transfer credential inquiry may inquire which credentials are transferable. In some embodiments, the transfer credential inquiry may indicate the credentials identified in 404 and/or an indication of the receiving device 104.

The source secure element 208 may identify the transfer credential inquiry received from the source credential application 206. The source secure element 208 may determine which of the credentials indicated in the transfer credential inquiry are transferable. In some embodiments, the source secure element 208 may store indications of which of the credentials maintained on the source device 202 are transferable. The source secure element 208 may determine the credentials that are transferable based on the maintained indications and/or the indication of the receiving device 104. The source secure element 208 may generate and transmit a result message to the source credential application 206 in 606. The result message may indicate the credentials that are transferable. The transferable credentials procedure 602 may be complete after transmission of the result message.

The source credential application 206 may identify the result message. The source credential application 206 may generate and transfer a transferable CoF entries message to the message session in 608. The transferable CoF entries message may include an indication of the credentials that transferable from the source device 202 to the receiving device 104.

The message session 112 may identify the transferable CoF entries message from the source credential application 206. The message session 112 may forward the transferable CoF entries message to the receiver credential application 108 in 502.

The receiver credential application 108 may identify the transferable CoF entries message from the message session 112. The receiver credential application 180 may determine the credentials available for transfer based on the transferable CoF entries message. The receiver credential application 108 may display the available CoF entries in 504. For example, the receiver credential application 108 may cause the receiving device 104 to display a graphical user interface that indicates the credentials available for transfer.

The user may initiate, via the user interface 102, credential migration in 506. For example, the user may interact, via the user interface 102, with the graphical user interface displayed on the receiving device 104 to indicate the credentials to be migrated from the source device 202 to the receiving device 104. The receiver credential application 108 may identify the interaction of the user with the graphical user interface. The receiver credential application 108 may determine the credentials for which the user is requesting migration based on the interaction.

The procedure of the credential migration procedure representation 100 may include a provision placeholder credential procedure 508. The provision placeholder credential procedure 508 may be initiated after the user initiates the credential migration. The provision placeholder credential procedure 508 may be optional and may be omitted in some embodiments.

For the provision placeholder credential procedure 508, the receiver credential application 108 may generate and transmit a credential serial number eligibility message to the account server 210 in 510. The credential serial number eligibility message may indicate the credentials intended to be migrated, such as by including identifiers (such as serail numbers) for the credentials.

The account server 210 may identify the credential serial number eligibility message received from the receiver credential application 108. The account server 510 may determine which of the credentials indicated by the credential serial number eligibility message are eligible. The account server 510 may generate and transmit a credential eligibility indication message to the receiver credential application 108 in 610. The credential eligibility indication message may indicate which of the credentials are determined to be eligible.

The receiver credential application 108 may identify the credential eligibility indication message received from the account server 210. The receiver credential application 108 may generate and transmit a credential serial number enable message to the account server 210 in 512. The credential serial number enable message may enable the provisioning of placeholder credentials for the credentials to be migrated. For example, the credential serial number enable message may indicate the credentials for which placeholder credentials are to be provisioned.

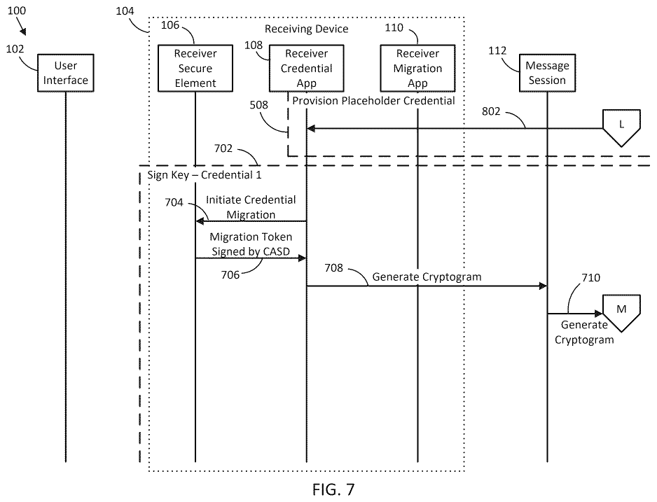

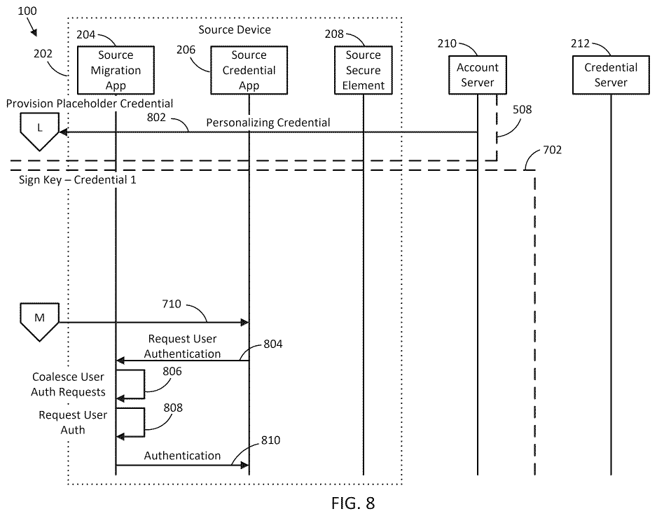

FIG. 7 illustrates a fourth part of the example credential migration procedure representation 100 showing the first portion of the elements in accordance with some embodiments. FIG. 8 illustrates the fourth part of the example credential migration procedure representation 100 showing the second portion of the elements in accordance with some embodiments.

The account server 210 may identify the credential serial number enable message received from the receiver credential application 108. The account server 210 may generate and transit a personalizing credential message to the receiver credential application 180 in 802. The personalizing credential message may provide personalized placeholder credentials to the receiver credential application 108, the personalized placeholder credentials being placeholders for the credentials to be migrated. The receiver credential application 108 may store the personalized placeholder credentials. The provision placeholder credential may be terminated after the personalizing credential message.

The procedure represented by the credential migration procedure representation 100 may include a sign key procedure 702 for a first credential type. The sign key procedure 702 for the first credential type may be performed when a credential of the first credential type is being migrated. In some embodiments, the first credential type may be an account credential type, such as a payment account type.

For the sign key procedure 702, the receiver credential application 108 may generate and transmit an initiate credential migration message to the receiver secure element 106 in 704. The initiate credential migration message may include an indication of the credentials to be migrated and/or one or more configurations for the credentials to be migrated. The configuration may indicate the process for the migration of the credentials, data to be exchanged for migration of the credentials, data to be stored for the credentials, configuration of how the data is to be stored for the credentials, or some combination thereof.

The receiver secure element 106 may identify the initiate credential migration message received from the receiver credential application 108. The receiver secure element 106 may identify the credentials to the migrated and/or the configuration from the initiate credential migration message. The receiver secure element 106 may generate and/or sign a migration token for completing the migration of the credential in 706. The migration token may be signed by a certificate authority security domain (CASD) corresponding to the receiver secure element 106. The CASD may be assigned to the receiver secure element 106 at production of the receiver secure element 106. The CASD may sign the migration token with a verified key assigned to the receiver secure element 106 at production of the receiver secure element 106. The key may be specific to the receiver secure element 106 and sharing of the key may be limited. Signing the migration token with key may bind the migration token to the receiver secure element 106. The receiver secure element 106 may further transmit the signed migration token to the receiver credential application 108 in 706.

The receiver credential application 108 may identify the signed migration token received from the receiver secure element 106. The receiver credential application may generate a cryptogram in 708. The cryptogram may include an indication of the credential to be migrated via the sign key procedure 702, an indication of a destination of the migration (such as a secure element identifier (SEID) of the receiver secure element 106), and/or the signed migration token. The receiver credential application 108 may transmit the cryptogram message to the message session 112 in 708, where the cryptogram message includes the cryptogram. The cryptogram message may further include a request for migration of the credentials.

The message session 112 may identify the cryptogram message received from the receiver credential application 108. The message session 112 may forward the cryptogram message to the source credential application 206 in 710.

The source credential application 206 may identify the cryptogram message received from the message session 112. The source credential application 206 may generate and transmit a user authentication request to the source migration application 204 in 804. The user authentication request may request authentication of the user associated with the credentials for migration and/or the user of the source device 202. The user authentication request may include an indication of the credentials to be migrated and/or an indication of the authentication procedures to be performed for migration of the credentials.

The source migration application 204 may identify the user authentication request received from the source credential application 206. The source migration application 204 may coalesce the user authentication requests in 806. For example, the source migration application 204 may determine the authentication procedures to be performed for all of the credentials to be migrated. The source migration application 204 may determine the authentication procedures to be performed based on the indication of the credentials and/or the indication of the authentication procedures in the user authentication request. The source migration application 204 may determine whether multiple credentials require a same authentication procedure. If the source migration application 204 determines that multiple credentials require a same authentication procedure, the source migration application 204 may cause the authentication procedure to be performed once and the results of the authentication procedure to be utilized for authentication for each of the credentials that require the authentication procedure. Coalescing the user authentication requests such that each authentication procedure is only performed once can limit the use of processing resources and reduce the time required for performing authentication as compared to the authentication procedures being performed separately for each credential (which could result in the same authentication procedure being performed multiple times). As processing resources could be limited for operations performed by the source device 202, limiting the resources needed for authentication procedures can be valuable.

The source migration application 204 may request user authentication in 808. For example, the source migration application 204 may cause one or more graphical user interfaces to be displayed on the source device 202 requesting authentication by the user of the source device 202. The source migration application 204 may cause the authentication procedures for the credentials to be performed by the source device 202 and may determine a result of the authentication procedures (e.g., whether the user has been authenticated). As the user authentication requests were coalesced in 806, each of the authentication procedures for the credentials may be performed once for authentication in 808.

The source migration application 204 may generate and transmit an authentication message to the source credential application 206 in 810. The authentication message may indicate whether the user was successfully authenticated in 808.

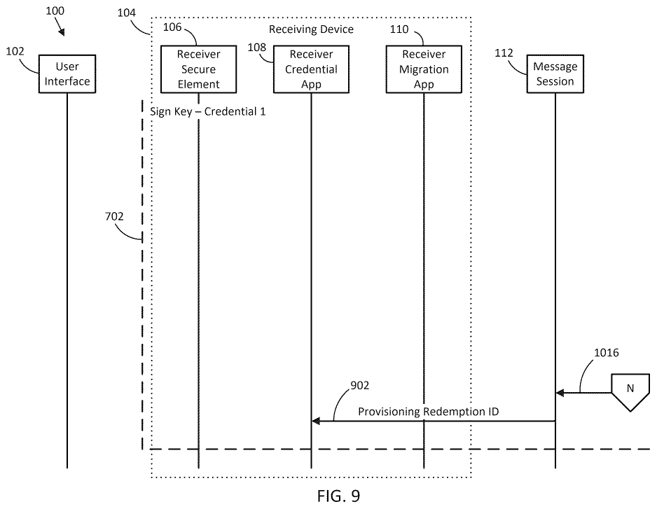

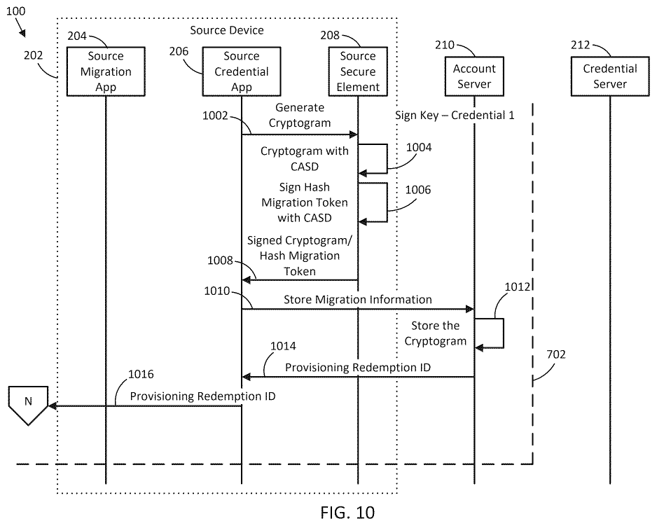

FIG. 9 illustrates a fifth part of the example credential migration procedure representation 100 showing the first portion of the elements in accordance with some embodiments. FIG. 10 illustrates the fifth part of the example credential migration procedure representation 100 showing the second portion of the elements in accordance with some embodiments.

The source credential application 206 may identify the authentication message received from the source migration application 204. The source credential application 206 may determine whether the user was successfully authenticated based on the authentication message. If the source credential application 206 determines that the was not successfully authenticated, the procedure may be terminated. If the source credential application 206 determines that the user was successfully authenticated, the source credential application 206 may generate and transmit a generate cryptogram message to the source secure element in 1002. The generate cryptogram message may include an application identifier (AID) corresponding to the source credential application, an indication of the result of the authentication, a destination secure element identifier (e.g., a secure element identifier of the receiver secure element 106), and/or the signed migration token.

The source secure element 208 may identify the generate cryptogram message from the source credential application 206. The source secure element 208 may generate one or more cryptograms in 1004. The source secure element 208 may generate the cryptograms with CASD over the cryptograms. The CASD may be the CASD for the source secure element 208. The source secure element 208 may generate one corresponding cryptogram for each credential to be migrated. The source secure element 208 may sign each of the cryptograms with the CASD for the source secure element 208. Signing the cryptograms with the CASD may bind the cryptograms to the source secure element 208.

The source secure element 208 may sign the hash migration token with the CASD in 1006. For example, the source secure element 208 may hash the migration token received in 1002. The source secure element 208 may then sign the hashed migration token with the CASD. For example, the source secure element 208 may sign the hashed migration token with a verified key assigned to the source secure element 208. Signing the hashed migration token with the key may bind the hashed migration token to the source secure element 208. The migration token may be signed by the key from the receiver secure element 106 and the key from the source secure element 208, which binds the migration token to both the receiver secure element 106 and the source secure element 208. Binding the migration token to both the receiver secure element 106 and the source secure element 208 may ensure that only the receiver secure element 106 and the source secure element 208 are able to access data protected by the migration token. Further, signing the hashed migration token with the key from the CASD can prove that the data is generated by the receiver secure element 106 and/or the source secure element 208 rather than an application.

The source secure element 208 may provide the signed cryptogram and/or the signed hash migration token to the source credential application 206 in 1008. For example, the source secure element 208 may generate and transmit a message to the source credential application 206, where the message may include the signed cryptogram and/or the signed hash migration token.

The source credential application 206 may identify the message received from the source secure element 208. The source credential application 206 may identify the signed cryptogram and/or the signed hash migration token in the message. The source credential application 206 may generate and/or transmit a store migration information message to the account server 210 in 1010. The store migration information message may include the signed cryptogram, the migration token, and/or the signed hashed migration token.

The account server 210 may identify the store migration information message received from the source credential application 206. The account server 210 may check the CASD of the signed migration token and/or the signed hashed migration token to validate that the receiving device 104 is performing migration and/or provisioning of the credentials. Further, the account server 210 may check the CASD of the signed hashed migration token to validate that the source device 202 is providing the cryptogram for provisioning of the credentials to the receiving device 104. The account server 210 may store the cryptogram in 1012. In some embodiments, the account server 210 may store the cryptogram for a duration of a session (such as six hours) and may delete the cryptogram at the end of the duration. In some embodiments, the account server 210 may store a session identifier (ID) corresponding to the session with cryptogram, where the session ID can be utilized to determine whether the session is still active.

The account server 210 may provide a provisioning redemption ID message to the source credential application 206 in 1014. The provisioning redemption ID message may include a list of provisioning identifiers that can be used for redeeming the cryptograms, the migration token, and/or the signed hashed migration token by the receiving device 104.

The source credential application 206 may identify the provisioning redemption ID message received from the account server 210. The source credential application 206 may forward the provision redemption ID message to the message session 112 in 1016.

The message session 112 may identify the provisioning redemption ID message received from the source credential application 206. The message session 112 may forward the provisioning redemption ID message to the receiver credential application 108 in 902. The receiver credential application 108 may store the list of provisioning identifiers from the provisioning redemption ID message. The provisioning redemption ID message being forwarded to the receiver credential application 108 in 902 may complete the sign key procedure 702 for the first credential type.

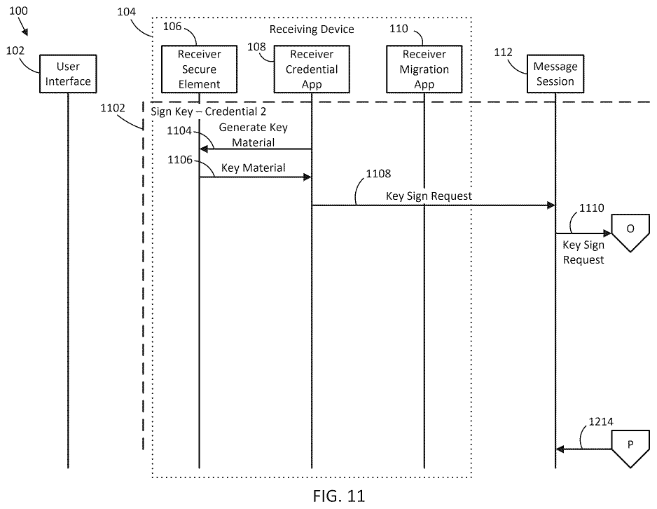

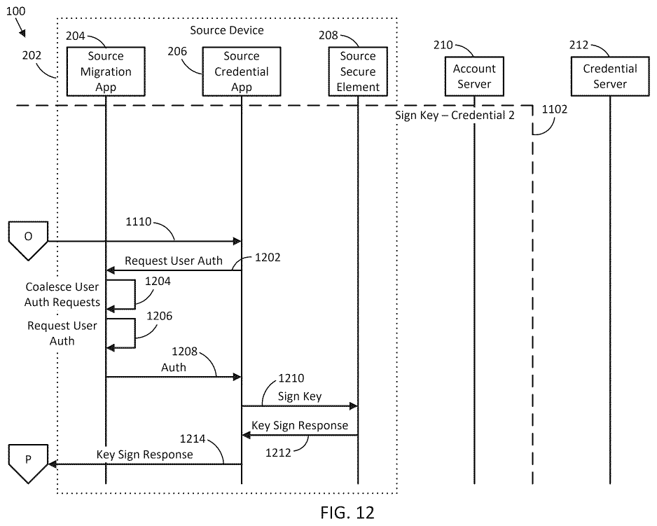

FIG. 11 illustrates a sixth part of the example credential migration procedure representation 100 showing the first portion of the elements in accordance with some embodiments. FIG. 12 illustrates the sixth part of the example credential migration procedure representation 100 showing the second portion of the elements in accordance with some embodiments.

The procedure represented by the credential migration procedure representation 100 may include a sign key procedure 1102 for a second credential type. The sign key procedure 1102 for the second credential type may be performed when a credential of the second credential type is being migrated. In some embodiments, the second credential type may be a key credential type, such as a key for accessing a securable entity (such as a vehicle and/or building).

For the sign key procedure 1102, the receiver credential application 108 may generate and transmit a generate key material message to the receiver secure element 106 in 1106. In some embodiments, the generate key material message may request generation of one or more progenitor keys. The generate key material message may include an indication of credentials to be migrated and/or one or more configurations for the credentials to be migrated. The configuration may indicate the process for the migration of the credentials, data to be exchanged for migration of the credentials, data to be stored for the credentials, configuration of how the data is to be stored for the credentials, or some combination thereof.

The receiver secure element 106 may identify the generate key material message received from the receiver credential application 108. The receiver secure element 106 may identify the credentials to the migrated and/or the configuration from the generate key material message. The receiver secure element 106 may generate and transmit key material to the receiver credential application 108 in 1106.

The receiver credential application 108 may identify the key material received from the receiver secure element 106. The receiver credential application 108 may generate and transmit a key sign request to the message session 112 in 1108. The key sign request may include the key material and/or an indication of one or more credentials to be migrated.

The message session 112 may identify the key sign request received from the receiver credential application 108. The message session 112 may forward the key sign request to the source credential application 206 in 1110.

The source credential application 206 may identify the key sign request received from the message session 112. The source credential application 206 may identify the key material and/or the indication of the one or more credentials to be migrated in the key sign request. The source credential application 206 may determine which credentials are requested to be migrated based on the key material and/or the indication of the one or more credentials. Further, the source credential application 206 may determine that user authentication from the source device 202 is to be obtained for migration of the credentials. The source credential application 206 may generate and transmit a request user authentication message to the source migration application 204 in 1202. The request user authentication message may include an indication of the credentials to be migrated and/or an indication of authentication procedures to be performed for migration of the credentials.

The source migration application 204 may identify the request user authentication message received from the source credential application 206. The source migration application 204 may coalesce the user authentication requests in 1204. For example, the source migration application 204 may determine the authentication procedures to be performed for all of the credentials to be migrated. The source migration application 204 may determine the authentication procedures to be performed based on the indication of the credentials and/or the indication of the authentication procedures in the user authentication request. The source migration application 204 may determine whether multiple credentials require a same authentication procedure. If the source migration application 204 determines that multiple credentials require a same authentication procedure, the source migration application 204 may cause the authentication procedure to be performed once and the results of the authentication procedure to be utilized for authentication for each of the credentials that require the authentication procedure. Coalescing the user authentication requests such that each authentication procedure is only performed once can limit the use of processing resources and reduce the time required for performing authentication as compared to the authentication procedures being performed separately for each credential (which could result in the same authentication procedure being performed multiple times). As processing resources could be limited for operations performed by the source device 202, limiting the resources needed for authentication procedures can be valuable.

The source migration application 204 may request user authentication in 1206. For example, the source migration application 204 may cause one or more graphical user interfaces to be displayed on the source device 202 requesting authentication by the user of the source device 202. The source migration application 204 may cause the authentication procedures for the credentials to be performed by the source device 202 and may determine a result of the authentication procedures (e.g., whether the user has been authenticated). As the user authentication requests were coalesced in 1204, each of the authentication procedures for the credentials may be performed once for authentication in 1206.

The source migration application 204 may generate and transmit an authentication message to the source credential application 206 in 1208. The authentication message may indicate whether the user was successfully authenticated in 1208.

The source credential application 206 may identify the authentication message received from the source migration application 204. The source credential application 206 may determine whether the user was successfully authenticated based on the authentication message. If the user was successfully authenticated, the source credential application 206 may generate and transmit a sign key request to the source secure element in 208 in 1210. The sign key request may include the key material, the indication of the one or more credentials, and/or an indication of the result of the user authentication.

The source secure element 208 may identify the sign key request received from the source credential application 206. The source secure element 208 may determine whether the user was successfully authenticated based on the sign key request. If the source secure element 208 determines that the user was successfully authenticated, the source secure element 208 may sign the key material and/or the credentials. The source secure element 208 may sign the key material and/or the credentials with an attestation and/or a secure element ID (SEID). Signing the key materials and/or the credentials with the attestation and/or the SEID may indicate that the source secure element 208 has approved the migration of the credentials. The source secure element 208 may generate and/or transmit a key sign response to the source credential application in 1212. The key sign response may include the signed key materials and/or the signed credentials.

The source credential application 206 may identify the key sign response received from the source secure element 208. The source credential application 206 may forward the key sign response to the message session 112 in 1214.

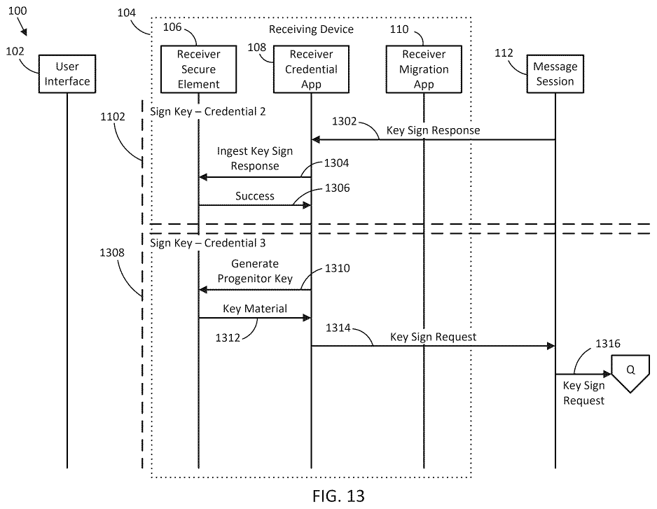

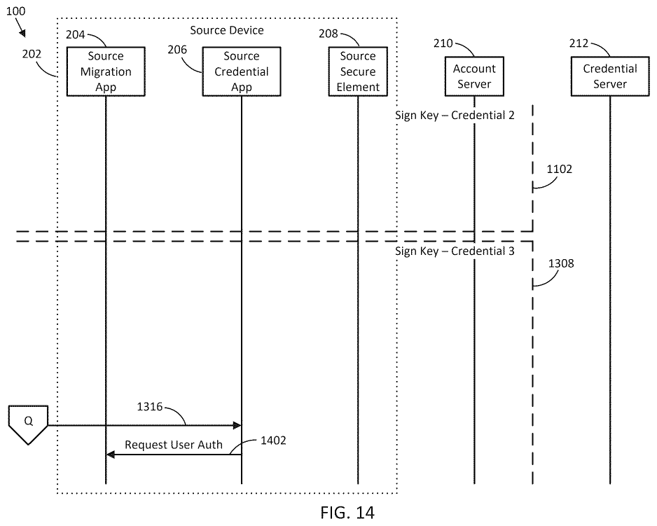

FIG. 13 illustrates a seventh part of the example credential migration procedure representation 100 showing the first portion of the elements in accordance with some embodiments. FIG. 14 illustrates the seventh part of the example credential migration procedure representation 100 showing the second portion of the elements in accordance with some embodiments.

The message session 112 may identify the key sign response received from the source credential application 206. The message session 112 may forward the key sign response to the receiver credential application 108 in 1302.

The receiver credential application 108 may identify the key sign response received from the message session 112. The receiver credential application 108 may forward the key sign response to the receiver secure element 106 in 1304, where the receiver secure element 106 is to ingest the key sign response. Ingesting the key sign response by the receiver secure element 106 may include identifying the signed key material and/or the signed credentials from the key sign response, and storing the signed key material and/or the signed credentials. Once the receiver secure element 106 has successfully stored the signed key material and/or the signed credentials, the receiving device 104 may be able to utilize the signed key material and/or the signed credentials via the receiver secure element 106.

The receiver secure element 106 may generate and transmit a result message to the receiver credential application 108 in 1306. The result message may indicate whether the receiver secure element 106 has successfully stored the signed key material and/or the signed credentials. The result message being transmitted to the receiver credential application 108 in 1306 may complete the sign key procedure 1102 for the second credential type.

The procedure represented by the credential migration procedure representation 100 may include a sign key procedure 1308 for a third credential type. The sign key procedure 1308 for the third credential type may be performed when a credential of the third credential type is being migrated. In some embodiments, the third credential type may be an identity credential type, such as a driver's license credential type, a visa credential type, and/or another user identification credential type.

For the sign key procedure 1308, the receiver credential application 108 may generate and transmit a generate progenitor key message to the receiver secure element 106 in 1310. In some embodiments, the generate progenitor key message may request generation of one or more progenitor keys. The generate key material message may include an indication of credentials to be migrated and/or one or more configurations for the credentials to be migrated. The configuration may indicate the process for the migration of the credentials, data to be exchanged for migration of the credentials, data to be stored for the credentials, configuration of how the data is to be stored for the credentials, or some combination thereof.

The receiver secure element 106 may identify the generate progenitor key message received from the receiver credential application 108. The receiver secure element 106 may identify the credentials to the migrated and/or the configuration from the generate progenitor key message. The receiver secure element 106 may generate and transmit key material to the receiver credential application 108 in 1312.

The receiver credential application 108 may identify the key material received from the receiver secure element 106. The receiver credential application 108 may generate and transmit a key sign request to the message session 112 in 1314. The key sign request may include the key material and/or an indication of one or more credentials to be migrated.

The message session 112 may identify the key sign request received from the receiver credential application 108. The message session 112 may forward the key sign request to the source credential application 206 in 1316.

The source credential application 206 may identify the key sign request received from the message session 112. The source credential application 206 may identify the key material and/or the indication of the one or more credentials to be migrated in the key sign request. The source credential application 206 may determine which credentials are requested to be migrated based on the key material and/or the indication of the one or more credentials. Further, the source credential application 206 may determine that user authentication from the source device 202 is to be obtained for migration of the credentials. The source credential application 206 may generate and transmit a request user authentication message to the source migration application 204 in 1402. The request user authentication message may include an indication of the credentials to be migrated and/or an indication of authentication procedures to be performed for migration of the credentials.

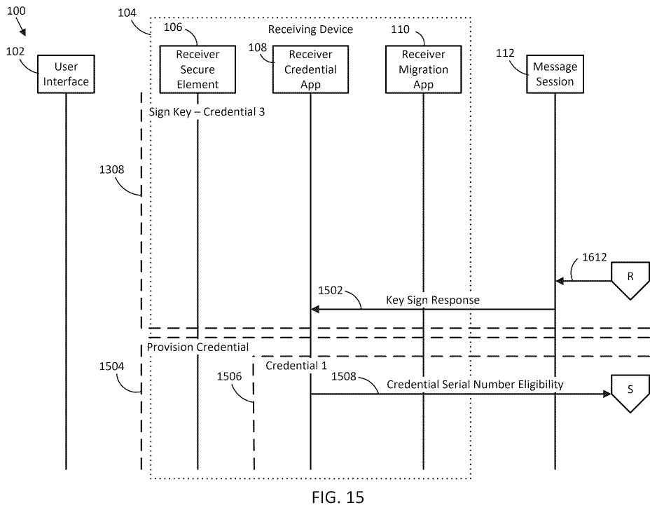

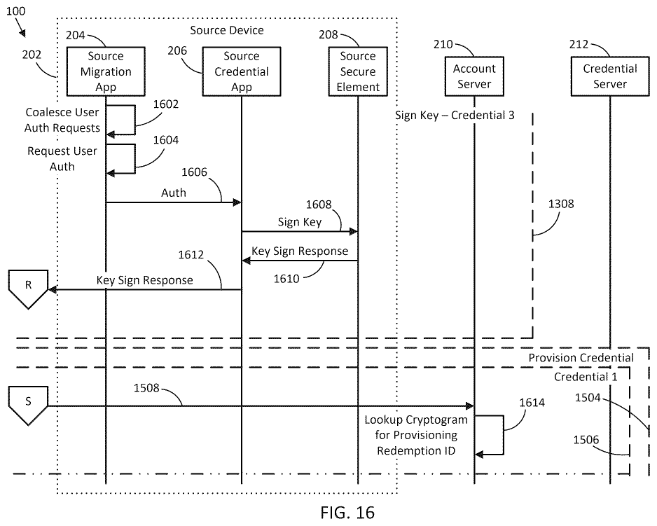

FIG. 15 illustrates an eighth part of the example credential migration procedure representation 100 showing the first portion of the elements in accordance with some embodiments. FIG. 16 illustrates the eighth part of the example credential migration procedure representation 100 showing the second portion of the elements in accordance with some embodiments.

The source migration application 204 may identify the request user authentication message received from the source credential application 206. The source migration application 204 may coalesce the user authentication requests in 1602. For example, the source migration application 204 may determine the authentication procedures to be performed for all of the credentials to be migrated. The source migration application 204 may determine the authentication procedures to be performed based on the indication of the credentials and/or the indication of the authentication procedures in the user authentication request. The source migration application 204 may determine whether multiple credentials require a same authentication procedure. If the source migration application 204 determines that multiple credentials require a same authentication procedure, the source migration application 204 may cause the authentication procedure to be performed once and the results of the authentication procedure to be utilized for authentication for each of the credentials that require the authentication procedure. Coalescing the user authentication requests such that each authentication procedure is only performed once can limit the use of processing resources and reduce the time required for performing authentication as compared to the authentication procedures being performed separately for each credential (which could result in the same authentication procedure being performed multiple times). As processing resources could be limited for operations performed by the source device 202, limiting the resources needed for authentication procedures can be valuable.

The source migration application 204 may request user authentication in 1604. For example, the source migration application 204 may cause one or more graphical user interfaces to be displayed on the source device 202 requesting authentication by the user of the source device 202. The source migration application 204 may cause the authentication procedures for the credentials to be performed by the source device 202 and may determine a result of the authentication procedures (e.g., whether the user has been authenticated). As the user authentication requests were coalesced in 1204, each of the authentication procedures for the credentials may be performed once for authentication in 1604.

The source migration application 204 may generate and transmit an authentication message to the source credential application 206 in 1606. The authentication message may indicate whether the user was successfully authenticated in 1604.

The source credential application 206 may identify the authentication message received from the source migration application 204. The source credential application 206 may determine whether the user was successfully authenticated based on the authentication message. If the user was successfully authenticated, the source credential application 206 may generate and transmit a sign key request to the source secure element in 208 in 1608. The sign key request may include the key material, the indication of the one or more credentials, and/or an indication of the result of the user authentication.

The source secure element 208 may identify the sign key request received from the source credential application 206. The source secure element 208 may determine whether the user was successfully authenticated based on the sign key request. If the source secure element 208 determines that the user was successfully authenticated, the source secure element 208 may sign the key material and/or the credentials. The source secure element 208 may sign the key material and/or the credentials with an attestation and/or an SEID. Signing the key materials and/or the credentials with the attestation and/or the SEID may indicate that the source secure element 208 has approved the migration of the credentials. The source secure element 208 may generate and/or transmit a key sign response to the source credential application in 1610. The key sign response may include the signed key materials and/or the signed credentials.

The source credential application 206 may identify the key sign response received from the source secure element 208. The source credential application 206 may forward the key sign response to the message session 112 in 1612.

The message session 112 may identify the key sign response received from the source credential application 206. The message session 112 may forward the key sign response to the receiver credential application 108 in 1502. The receiver credential application may store the signed key materials and/or the signed credentials. The key sign response being transmitted to the receiver credential application 108 in 1502 may complete the sign key procedure 1308 for the third credential type.

The procedure represented by the credential migration procedure representation 100 may include a provision credential procedure 1504. The provision credential procedure 1504 may provision credentials from the source device 202 to the receiving device 104 as part of the migration of credentials. The provision credential procedure 1504 may include different operations for different credentials being migrated, as described further. One provision credential procedure 1504 may be performed for provisioning multiple credentials and/or multiple credential types in some embodiments. In other embodiments, one provision credential procedure 1504 may be performed for each credential and/or each credential type, resulting in a number of provision credential procedures being performed.

The provision credential procedure 1504 may include an eligibility procedure 1506 for the first credential type. The eligibility procedure 1506 may be performed when a credential of the first credential type is being provisioned as part of the migration. In some embodiments, the first credential type may be an account credential type, such as a payment account type. The eligibility procedure 1506 may have two alternative groups of operations, where one of the alternative groups is performed in an embodiment.

For a first alternative, the eligibility procedure 1506 may initiate with the receiver credential application 108 generating and transmitting a credential serial number eligibility message to the account server 210 in 1508. The credential serial number eligibility message may include the list of provisioning identifiers of the first credential type to be migrated, the list of provisioning identifiers being from the provisioning redemption ID message received by the receiver credential application 108 in 902. The credential serial number eligibility message may request an eligibility poll to determine the eligibility of migrating the credentials corresponding to the list of provisioning identifiers.

The account server 210 may identify the credential serial number eligibility message received from the receiver credential application 108. The account server 210 may determine the credentials to be provisioned based on the list of provisioning identifiers from the credential serial number eligibility message. The account server 210 may look up the cryptogram for the provisioning identifiers and may utilize the cryptogram to validate the provisioning identifiers in 1614. In some embodiments, the account server 210 may further identify a session ID associated with the cryptogram and determine whether the session is still active based on the session ID. If the session is no longer active, the account server 210 may determine that the provisioning identifiers are invalid. If the provisioning identifiers are successfully validated, the account server 210 may determine that the credentials corresponding to the provisioning identifiers are eligible for migration. For any provisioning identifiers that are not successfully validated, the account server 210 may determine that the credentials corresponding to the provisioning identifiers that were not successfully validated are not eligible for migration. The account server 210 completing the validation in 1614 may complete the first alternative of the eligibility procedure 1506.

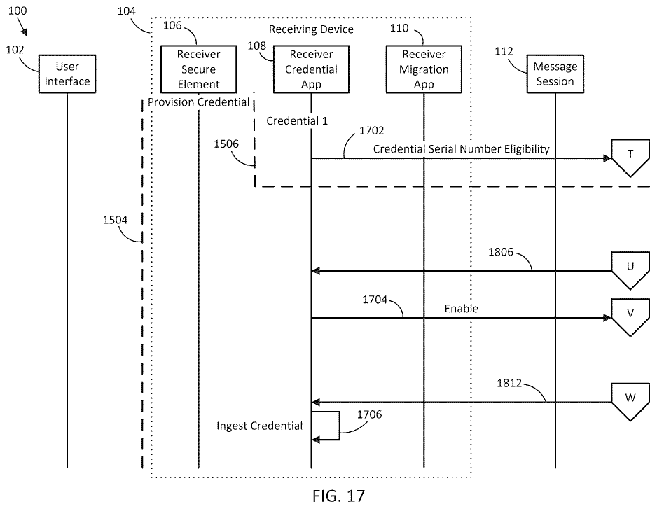

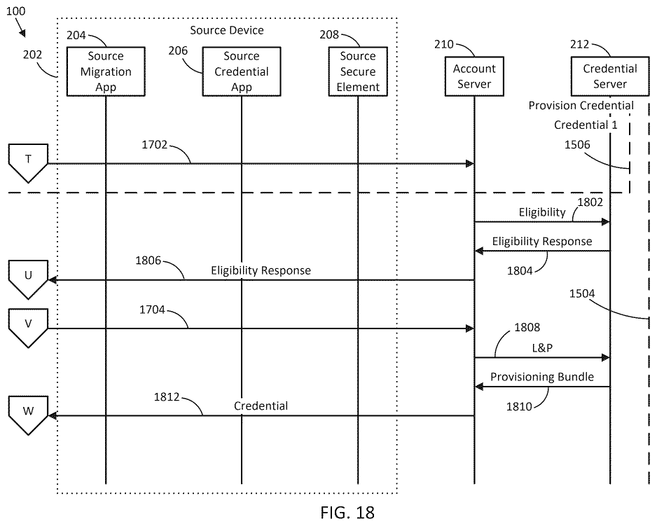

FIG. 17 illustrates a ninth part of the example credential migration procedure representation 100 showing the first portion of the elements in accordance with some embodiments. FIG. 18 illustrates the ninth part of the example credential migration procedure representation 100 showing the second portion of the elements in accordance with some embodiments.

For a second alternative, the eligibility procedure 1506 may initiate with the receiver credential application 108 generating and transmitting a credential serial number eligibility message to the account server 210 in 1702. The credential serial number eligibility message may include the cryptogram generated in 708. The account server 210 may identify the credential serial number eligibility received from the receiver credential application 108 and identify the cryptogram. The account server 210 may determine the eligibility of migration of the credentials to the receiving device 104 based on the cryptogram, such as by comparing the cryptogram received in the credential serial number eligibility message with the credential received in the generate cryptogram message of 1002. The second alternative may be completed with the transmission of the credential serial number eligibility message.

The account server 210 may generate and transmit an eligibility message to the credential server 212 in 1802. The eligibility message may indicate whether the credentials are eligible for migration based on the determination of eligibility from the first alternative or the second alternative of the eligibility procedure 1506. In some embodiments, the eligibility message may include the cryptogram.

The credential server 212 may identify the eligibility message received from the account server 210. The credential server 212 may generate and transmit an eligibility response to the account server 210 in 1804. The credential server 212 may determine the eligibility for migration of the credentials based on data within the eligibility message. In some embodiments, the credential server 212 may store additional information regarding eligibility of the credentials for migration (such as migration limitations and/or requirements for credentials defined by an operator of the credential server), where the credential server 212 may determine the eligibility for migration of the credentials based on the additional information. The eligibility response may indicate which of the credentials are eligible for migration to the receiving device 104.

The account server 210 may identify the eligibility response received from the credential server 212. The account server 210 may forward the eligibility response to the receiver credential application 108 in 1806.

The receiver credential application 108 may identify the eligibility response received from the account server 210. The receiver credential application 108 may determine which credentials are eligible for migration based on the eligibility response. The receiver credential application 108 may generate and transmit an enable message to the account server 210 in 1704. The enable message may indicate that the eligible credentials are to be enabled for migration.

The account server 210 may identify the enable message received from the receiver credential application 108. The account server 210 may generate and transmit an L and P message to the credential server 212 in 1808. The L and P message may include a request to provision the credential indicated to be enabled for migration in the enable message. Further, the L and P message may indicate a locator of the credentials to be provisioned. For example, the L and P message may include locators corresponding to the credentials to be provisioned, where the locators can be utilized for identifying the credentials to be provisioned.

The credential server 212 may identify the L and P message received from the account server 210. The credential server 212 may determine the credentials to be provisioned based on the L and P message. Further, the credential server 212 may determine one or more provisioning bundles to be sent corresponding to the credentials to be provisioned. The credential server 212 may generate and/or transmit a provisioning bundle message to the account server 210 in 1810. The provisioning bundle message may include one or more provisioning bundles for provisioning the credentials to the receiving device 104. The provisioning bundles may include the credentials and/or data for utilization of the credentials.

The account server 210 may identify the provisioning bundle message received from the credential server 212. The account server 210 may identify the credentials and/or date for utilization of the credentials from the provisioning bundle message. The account server 210 may generate and/or transmit a credential message to the receiver credential application 108 in 1812. The credential message may include the credentials being provisioned to the receiving device 104. In some instances, the credential message may include multiple credentials. Having multiple credentials being provisioned in the single credential message rather than having only a single credential being provisioned in a single credential message can reduce required signaling between the account server 210 and the receiving device 104. Reducing the signaling can reduce the power required for provisioning multiple credentials, as well as reducing the time for provisioning multiple credentials. Additionally, having multiple credentials in the single credential message can reduce the amount of time other operations within the procedure are performed, such as reducing a number of L and P messages that are exchanged and/or reducing the number of provisioning bundle messages that are exchanged.

The receiver credential application 108 may identify the credential message received from the account server 210. The receiver credential application 108 may ingest the credentials in 1706. The ingesting of the credentials may include storing the credentials.

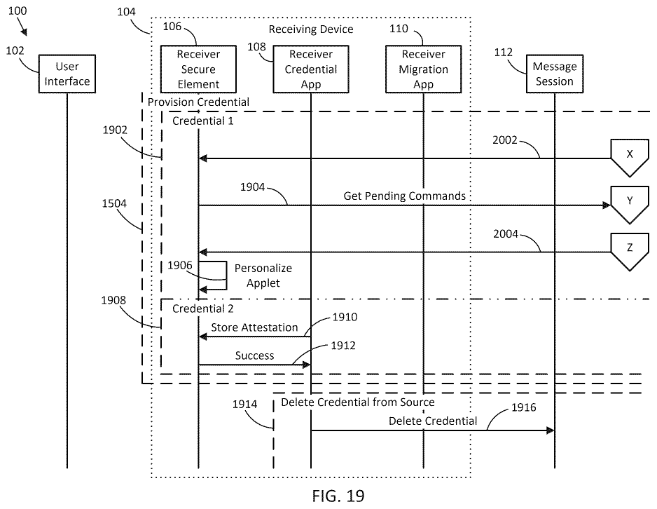

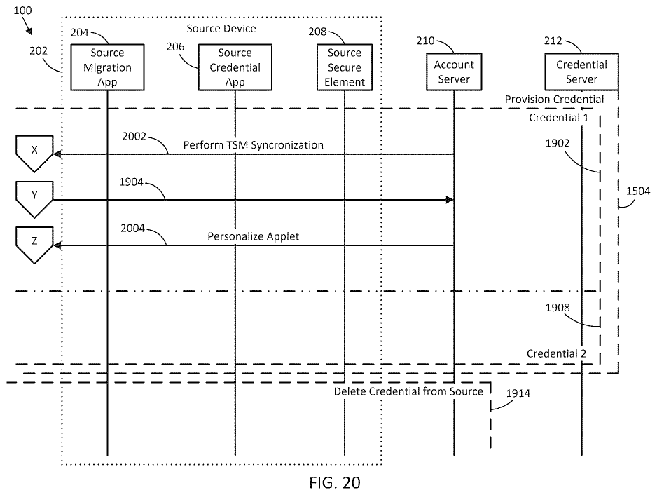

FIG. 19 illustrates a tenth part of the example credential migration procedure representation 100 showing the first portion of the elements in accordance with some embodiments. FIG. 20 illustrates the tenth part of the example credential migration procedure representation 100 showing the second portion of the elements in accordance with some embodiments.

The procedure represented by the credential migration procedure representation 100 may include a secure applet synchronization procedure. The secure applet synchronization procedure may include alternative operations for different credential types. For example, the secure applet synchronization procedure may include a first alternative 1902 for a first credential type and a second alternative 1908 for a second credential type. In some embodiments, the first credential type may be an account credential type, such as a payment account type. In some embodiments, the second credential type may be a key credential type, such as a key for accessing a securable entity (such as a vehicle and/or building), and/or an identity credential type (such as a driver's license credential type, a visa credential type, and/or another user identification credential type).

In the first alternative 1902 of the secure applet synchronization procedure, the account server 210 may generate and/or transmit a perform trusted service manager (TSM) synchronization message to the receiver secure element 106 in 2002. The perform TSM synchronization message may request synchronization between the account server 210 and the receiver secure element 106 for the provisioned credentials.

The receiver secure element 106 may identify the perform TSM synchronization message received from the account server 210. The receiver secure element 106 may determine that the account server 210 is attempting to synchronize with the receiver secure element 106 regarding the provisioned credentials. The receiver secure element 106 may generate and/or transmit a get pending commands message to the account server 210 in 1904. The get pending commands message may request pending commands from the account server 210 to synchronize the receiver secure element 106 with the account server 210 for the provisioned credentials.

The account server 210 may identify the get pending commands message received from the receiver secure element 106. The account server 210 may generate and transmit a personalize applet message to the receiver secure element 106 in 2004. The personalize applet message may include instructions for synchronizing the receiver secure element 106 with the account server 210.

The receiver secure element 106 may identify the personalize applet message received from the account server 210. The receiver secure element 106 may identify the instructions from the personalize applet message. The receiver secure element 106 may perform operations in accordance with the instructions to personalize an applet of the receiver secure element 106. The applet of the receiver secure element 106 may manage the credentials stored by the receiver secure element 106 and/or control interactions between the receiver secure element 106 and the receiver credential application 108. The receiver secure element 106 personalizing the applet may complete the first alternative 1902 of the secure applet synchronization procedure.

In the second alternative 1908 of the secure applet synchronization procedure, the receiver credential application 108 may generate and/or transmit a store attestation message to the receiver secure element 106 in 1910. The store attestation message may include attestation information for the credentials.

The receiver secure element 106 may identify the store attestation message received from the receiver credential application 108. The receiver secure element 106 may store the attestation from the store attestation message. The receiver secure element 106 may generate and/or transmit a result message to the receiver credential application 108 in 1912. The result message may indicate whether the receiver secure element 106 successfully stored the attestation.

In some instances, the procedure represented by the credential migration procedure representation 100 may include a delete credential procedure 1914. The delete credential procedure 1914 may delete the credentials from the source device 202 after the credentials have been provisioned to the receiving device 104. In other instances, the delete credential procedure 1914 may be omitted. In some embodiments, one or both of the receiving device 104 and the source device 202 may allow a user to indicate whether the delete credential procedure 1914 is to be performed.

The delete credential procedure 1914 may initiate with receiver credential application 108 generating and/or transmitting a delete credential message to the message session 112 in 1916. The receiver credential application 108 may generate and/or transmit the delete credential message after the credentials have been provisioned to the receiving device 104. The delete credential message may include an indication that the credentials have been provisioned to the receiving device 104, an indication to delete the credentials from the source device 202, and/or identifiers of the credentials to be deleted.

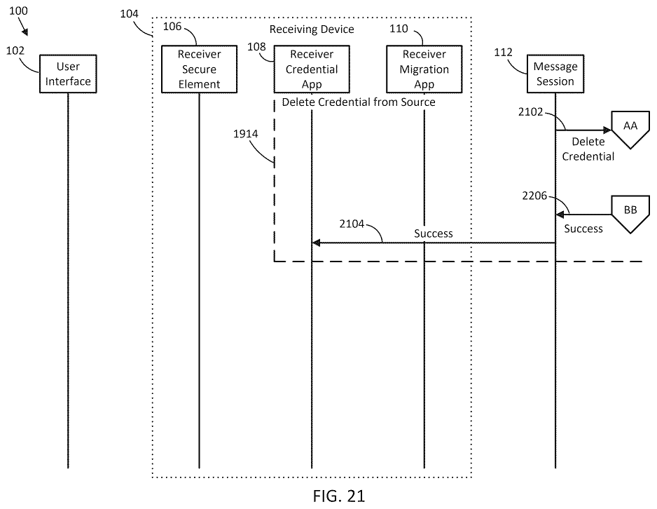

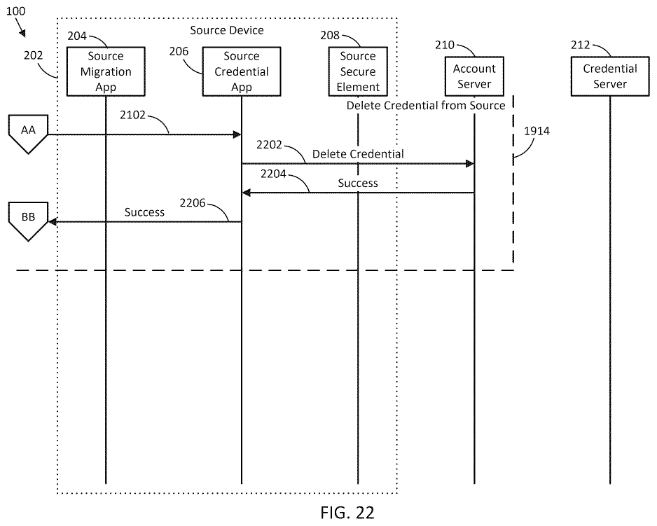

FIG. 21 illustrates an eleventh part of the example credential migration procedure representation 100 showing the first portion of the elements in accordance with some embodiments. FIG. 22 illustrates the eleventh part of the example credential migration procedure representation 100 showing the second portion of the elements in accordance with some embodiments.

The message session 112 may identify the delete credential message received from the receiver credential application 108. The message session 112 may forward the delete credential message to the source credential application 206 in 2102.

The source credential application 206 may identify the delete credential message received from the message session 112. The source credential application 206 may determine the credentials to be deleted from the source device 202 from the delete credential message. The source credential application 206 may delete the credentials from the source device 202. The source credential application 206 may further forward the delete credential message to the account server 210 in 2202.

The account server 210 may identify the delete credential message received from the source credential application 206. The account server 210 may de-provision the credentials from the source device 202 based on the delete credential message. De-provisioning the credentials may include preventing, by the account server 210, the source device 202 from utilizing the credentials. Further, the account server 210 may generate and/or transmit a deletion result message to the source credential application 206 in 2204. The deletion result message may indicate whether the credentials were successfully de-provisioned from the source device 202 and/or which credentials were successfully de-provisioned from the source device 202.

The source credential application 206 may identify the deletion result message received from the account server 210. The source credential application 206 may forward the deletion result message to the message session 112 in 2206.

The message session 112 may identify the deletion result message received from the source credential application 206. The message session 112 may forward the deletion result message to the receiver credential application 108 in 2104.

The receiver credential application 108 may identify the deletion result message received from the message session 112. The receiver credential application 108 may determine whether the credentials were successfully deleted from the source device 202 based on the deletion result message.

FIG. 23 illustrates a block diagram of an example user device 2300 in accordance with some embodiments. The block diagram illustrates various example components and features of the example user device 2300.

The user device 2300 may include a secure element 2310, a wireless interface 2312, a reader 2306 (such as a magnetic card reader that can read a magnetic stripe of a physical object), a communication interface 2308, a control circuit 2316, a processing unit 2318 on which an operating system (OS) of the user device 2300 is running, an input/output (I/O) Controller 2314, a display 2304, a keypad 2302, and/or a memory 2320. Examples of OS running on the processing unit 2318 may include, but are not limited to, a version of iOS®, or a derivative thereof, available from Apple Inc.; a version of Android OS®, or a derivative thereof, available from Google Inc.; a version of PlayBook OS®, or a derivative thereof, available from RIM Inc. It is understood that other proprietary OS or custom made OS may be equally used without departing from the scope of the present invention.

In some embodiments, the user device 2300 may be controlled by the processing unit 2318 and/or the control circuit 2316 to provide the processing capability required to execute the OS of the user device 2300. The processing unit 2318 may include a single processor or a plurality of processors. For example, the processing unit 2318 may include “general purpose” microprocessors, a combination of general and special purpose microprocessors, instruction set processors, graphic processors, or special purpose processors. The control circuit 2316 may include one or more data buses for transferring data and instructions between components of the user device 2300. The control circuit 2316 may also include on board memory for caching purposes.

In some embodiments, information used by the processing unit 2318 may be located in the memory 2320. The memory 2320 may be a non-volatile memory such as read only memory, flash memory, a hard drive, or any other suitable optical, magnetic, or solid-state computer readable media, as well as a combination thereof. The memory 2320 may be used for storing data required for the operation of the processing unit 2318 as well as other data required for the user device 2300. For example, the memory 2320 may store the firmware of the user device 2300. The firmware may include the OS, as well as other programs that enable various functions of the user device 2300, graphical user interface (GUI) functions, or processor functions. The memory 2320 may store components for a GUI, such as graphical elements, screens, and templates. The memory 2320 may also include data files such as connection information (e.g. information used to establish a communication), or data allowing the user device 2300 to run the receiver secure element 106 (FIG. 1), the receiver credential application 108 (FIG. 1), the receiver migration application 110 (FIG. 1), the source migration application 204 (FIG. 2), the source credential application 206 (FIG. 2), and/or the source secure element 208 (FIG. 2). The data stored in the memory 2320 may allow the user device 2300 to perform the operations described in relation to the representation 100 (FIG. 1), such as data to generate user interfaces on the display 2304 utilized during performance of the operations. In addition, the memory 2320 may store data to control the activation/deactivation of the wireless interface 2312 and, when activated, control the operation mode of the wireless interface 2312 (e.g., passive or active).

The communication interface 2308 may provide additional connectivity channels for receiving and transmitting information. For example, the communication interface 2308 may provide connectivity functions to allow the user device 2300 to communicate with the message session 112 (FIG. 1), the account server 210 (FIG. 2), and/or the credential server 212 (FIG. 2). The communication interface 2308 may represent, for example, one or more network interface cards (NIC) or a network controller as well as associated communication protocols. The communication interface 2308 may include several types of interfaces, including but not limited to, a wireless local area network (WLAN) interface, a local area network (LAN) interface, a wide area network (WAN) interface, a multimedia message service (MMS), and a short message service (SMS) interface.

In certain embodiments, the user device 2300 may use a device identification networking protocol to establish a connection with an external device through a network interface. For example, both the user device 2300 and the external device may broadcast identification information using internet protocol (IP). The devices may then use the identification information to establish a network connection, such as a LAN connection, between the devices.

The wireless interface 2312 may allow for close range communication at various data rates complying, for example, with standards such as ISO 14443, ISO 15693, ISO 18092 or ISO 21481. In some embodiments, the wireless interface 2312 may be implemented through a near file communication (NFC) device embedded in a chipset that is part of the user device 2300. Alternatively, the wireless interface 2312 may be implemented through an NFC device that is a separate component and that communicates through the communication interface 2308 with the user device 2300, or through an additional port of the user device 2300. The wireless interface 2312 may include one or more protocols, such as the Near Field Communication Interface and Protocols (NFCIP-1) for communicating with another NFC enabled device. The protocols may be used to adapt the communication speed and to designate one of the connected devices as the initiator device that controls the near field communication. In certain embodiments, the wireless interface 2312 may be used to receive information, such as the service set identifier (SSID), channel, and encryption key, used to connect through another communication interface. In one embodiment of the present invention, the wireless interface 2312 is in direct communication with the secure element 2310 and/or the control circuit 2316. In other embodiments, the wireless interface 2312 may be connected, for example but without being limitative, to the control circuit 2316, the I/O controller 2314, or both.

The wireless interface 2312 may control the near field communication mode of the user device 2300. For example, the wireless interface 2312 may be configured to switch the user device 2300 between a reader/writer mode for reading NFC tags, a peer-to-peer mode for exchanging data with another NFC enabled device, and a card emulation mode for allowing another NFC enabled device to read data. The wireless interface 2312 also may be configured to switch the user device 2300 between an active mode where the user device 2300 generates its own RF field and a passive mode where the user device 2300 uses load modulation to transfer data to another device generating an RF field. Operation in passive mode may prolong the battery life of the user device 2300. In certain embodiments, the modes of the wireless interface 2312 may be controlled based on user or manufacturer preferences.

In an embodiment, the wireless communication of the wireless interface 2312 may occur within a range of approximately 2 to 4 cm. The close range communication with the wireless interface 2312 may take place via magnetic field induction, allowing the wireless interface 2312 to communicate with other NFC devices or to retrieve data from tags having RFID circuitry. The wireless interface 2312 may be used to acquire data from the physical objects (such as NFC-enabled cards) or from other devices.

The secure element 2310 may be embodied in a chipset connected to the control circuit 2316 that cooperates with the wireless interface 2312 to provide operations described in relation to the procedure of the representation 100 in some embodiments. In other embodiments, the secure element 2310 may be embodied in a chipset connected to the control circuit 2316 that cooperates with the reader 2306 to retrieve data from physical objects. In some other embodiments, the secure element 2310 may be embodied in a chipset connected to the control circuit 2316 that cooperates with the reader 2306 to provide the operations described in relation to the representation 100. For example, but without being limitative, the chipset on which the secure element 2310 is embodied may be a model of the ST32® or ST33® chipset family, or a derivative thereof, available from STMicroelectronics Inc.

In some embodiments, the secure element 2310 may be manufactured with security features that may not be provided after manufacturing and which may limit access to the secure element 2310. For example, the secure element 2310 may be assigned one or more keys and/or other security elements at the time of manufacturing. The sharing of the keys and/or other security elements may be limited after manufacturing, which can limit bad actors from obtaining the keys and/or other security elements.

The I/O Controller 2314 may provide the infrastructure for exchanging data between the control circuit 2316, the processing unit 2318, and/or the input/output devices. The I/O controller 2314 may include one or more integrated circuits and may be integrated within the control circuit 2316 or exist as a separate component. The I/O controller 2314 may provide the infrastructure for communicating with the display 2304, the keypad 2302, and/or the reader 2306. The I/O controller 2314 may also provide the infrastructure for communicating with external devices.

In some embodiments, the user device 2300 may be a mobile device. For example, the mobile device may be, but is not limited to, a mobile phone (for example a model of an iPhone®, or a derivative thereof, available from Apple Inc.; a model of a Blackberry®, or a derivative thereof, available from RIM Inc.; a model of a Galaxy®, or a derivative thereof, available from Samsung Inc.), a tablet computer (for example a model of an iPad®, or a derivative thereof, available from Apple Inc.; a model of a Galaxy Tab®, or a derivative thereof, available from Samsung Inc.; a model of a PlayBook®, or a derivative thereof, available from RIM Inc.), and a laptop computer. To facilitate transport and ease of motion, the user device 2300 may include an integrated power source for powering the user device 2300. The power source may include one or more batteries, such as a Li-ion battery, which may be user-removable or secured to the user device 2300.

In alternative embodiments, the secure element 2310, the wireless interface 2312, the reader 2306, or some combination thereof may be embedded on non-mobile devices.

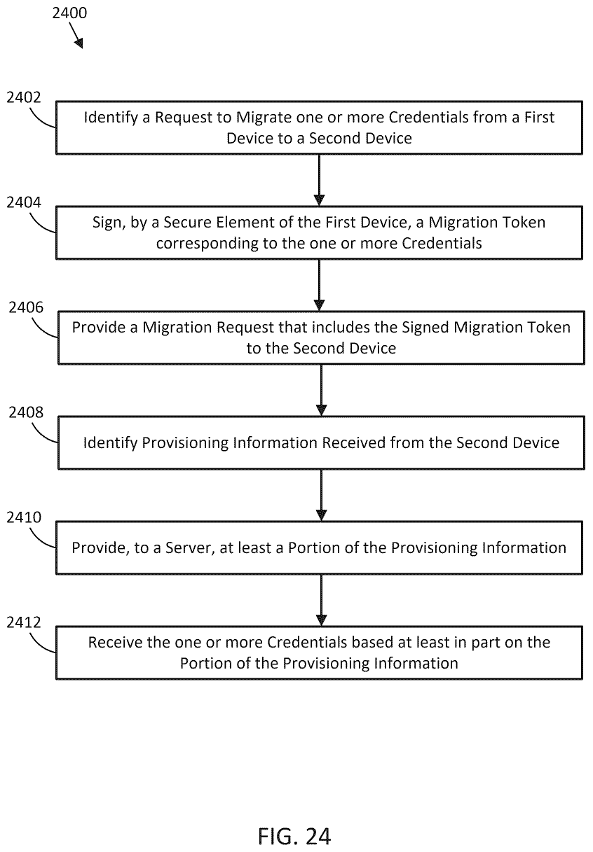

FIG. 24 illustrates an example procedure 2400 for migrating one or more credentials in accordance with some embodiments. The procedure 2400 may be performed by a device, such as the receiving device 104 (FIG. 1). The device performing the procedure 2400 is referred to as the first device in the description of the procedure 2400.

The procedure 2400 may include identifying, by the first device, a request to migrate the one or more credentials from the second device to the first device in 2402.

The procedure 2400 may include signing, by a secure element of the first device, a migration token corresponding to the one or more credentials in 2404. In some embodiments, wherein the migration token is signed with a certificate authority secure domain (CASD) key corresponding to the secure element. The CASD key may have been assigned to the secure element at production of the secure element.

The procedure 2400 may include providing, by the first device to the second device, a migration request that includes the signed migration token in 2406.

The procedure 2400 may include identifying, by the first device, provisioning information received from the second device in 2408. The provisioning information may be received from the second device based at least in part on the signed migration token. In some embodiments, the provisioning information may include one or more provisioning tokens corresponding to the one or more credentials. The one or more credentials may be received based at least in part on the one or more provisioning tokens.

In some embodiments, the secure element may be a first secure element. In these embodiments, the provisioning information may include a signed, hashed migration token corresponding to the migration token. The signed, hashed migration token may be signed with a certificate authority security domain (CASD) key corresponding to a second secure element of the second device. The CASD key may have been assigned to the second secure element at production of the second secure element.

The procedure 2400 may include providing, by the first device to a server, at least a portion of the provisioning information in 2410.

The procedure 2400 may include receiving, by the first device, the one or more credentials based at least in part on the portion of the provisioning information in 2412.

In some embodiments, the procedure 2400 may further include providing, by the first device to the server, a request for provisioned credentials available for migration for an account associated with the first device, the provisioned credentials being provisioned to the second device. The procedure 2400 in these embodiments may further include identifying, by the first device, an indication of one or more provisioned credentials available for migration, the one or more provisioned credentials from the provisioned credentials provisioned to the second device. Further, the procedure 2400 may include presenting, by the first device, a representation of the one or more provisioned credentials available for selection. Identifying the request to migrate the one or more credentials may include identifying a selection of the one or more credentials from the one or more provisioned credentials included in the presented representation. In some of these embodiments, the indication of the one or more provisioned credentials includes one or more provisioned identifiers corresponding to the one or more provisioned credentials. Further, the procedure 2400 may include determining one or more identifiers corresponding to the one or more credentials from the one or more provisioned identifiers based at least in part on the selection of the one or more credentials in some of these embodiments. The migration request may further include the one or more identifiers.

In some embodiments, the procedure 2400 may further include establishing, by the first device, a session with the second device. The procedure 2400 may further include identifying, by the first device, a session identifier (ID) associated with the session in accordance with some embodiments. The migration request may further include the session identifier, and the provisioning information may be received based at least in part on the session identifier.

Any one or more of the operations in FIG. 24 may be performed in a different order than shown and/or one or more of the operations may be performed concurrently in embodiments. Further, it should be understood that one or more of the operations may be omitted from and/or one or more additional operations may be added to the procedure 2400 in other embodiments.

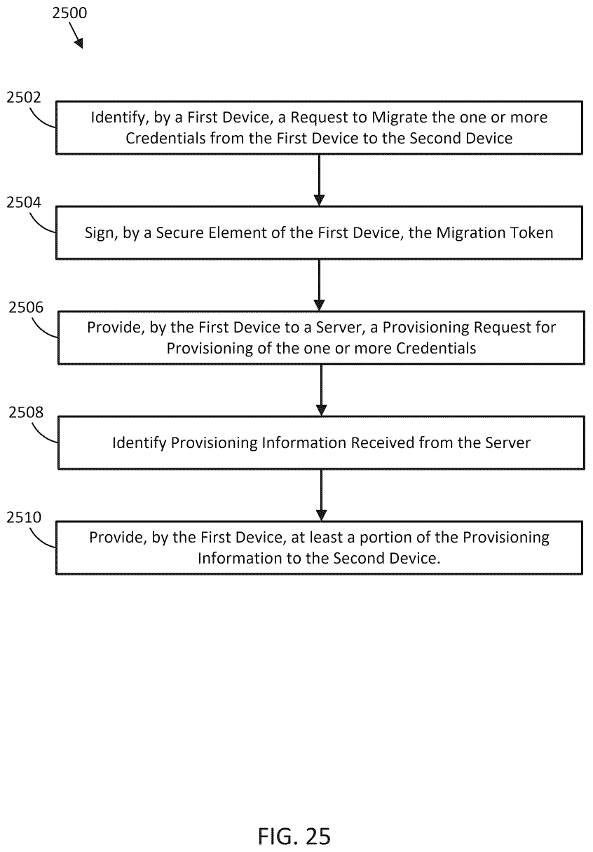

FIG. 25 illustrates an example procedure 2500 for provisioning one or more credentials in accordance with some embodiments. The procedure 2500 may be performed by a device, such as the source device 202 (FIG. 2). The device performing the procedure 2500 may be referred to as the first device in the description of the procedure 2500.

The procedure 2500 may include identifying, by the first device, a request to migrate the one or more credentials from the first device to the second device in 2502. The request may include a migration token corresponding to the one or more credentials.

The procedure 2500 may include signing, by a secure element of the first device, the migration token in 2504. In some embodiments, the signed migration token is signed with a certificate authority secure domain (CASD) key corresponding to the secure element. The CASD key may have been assigned to the secure element at production of the secure element.

In some embodiments, the secure element is first secure element. Further, the migration token identified in the request may be signed with a certificate authority secure domain (CASD) key corresponding to a second secure element of the second device. The CASD key may have been assigned to the second secure element at production of the second secure element.

The procedure 2500 may include providing, by the first device to a server, a provisioning request for provisioning of the one or more credentials in 2506. The provisioning request may include the signed migration token.

The procedure 2500 may include identifying, by the first device, provisioning information received from the server in 2508, the provisioning information for provisioning the one or more credentials to the second device.

The procedure 2500 may include providing, by the first device, at least a portion of the provisioning information to the second device in 2510.

In some embodiments, the procedure 2500 may include hashing, by the first device, the migration token to produce a hashed migration token. Signing the migration token may include signing the hashed migration token.

In some embodiments, the procedure 2500 may include determining, by the first device, one or more authentication procedures corresponding to each of the one or more credentials. Further, the procedure 2500 may include coalescing, by the first device, the one or more authentication procedures into an authentication procedure set for authentication for all of the one or more credentials. The procedure 2500 may include performing, by the first device, the authentication procedure set, and determining, by the first device, to sign the migration token based at least in part on successful authentication from the authentication procedure set.

In some of these embodiments, coalescing the one or more authentication procedures may include determining that an authentication procedure is to be performed for a first credential of the one or more credentials, and determining that the authentication procedure is to be performed for a second credential of the one or more credentials, wherein the authentication procedure set may include the authentication procedure. In these embodiments, performing the authentication procedure set may include performing the authentication procedure a single time for authentication for both the first credential and the second credential.

In some embodiments, the procedure 2500 may include generating, by the secure element, one or more cryptograms corresponding to the one or more credentials. The provisioning request may further include the one or more cryptograms, the one or more cryptograms to be utilized for validating migration of the one or more credentials from the first device to the second device.

In some of these embodiments, the procedure 2500 may include signing, by the secure element, the one or more cryptograms with a certificate authority secure domain (CASD) key corresponding to the secure element. The CASD key may have been assigned to the secure element at production of the secure element. In some of these embodiments, the generating the one or more cryptograms may comprise generating one cryptogram for each of the one or more credentials.

Any one or more of the operations in FIG. 25 may be performed in a different order than shown and/or one or more of the operations may be performed concurrently in embodiments. Further, it should be understood that one or more of the operations may be omitted from and/or one or more additional operations may be added to the procedure 2500 in other embodiments.

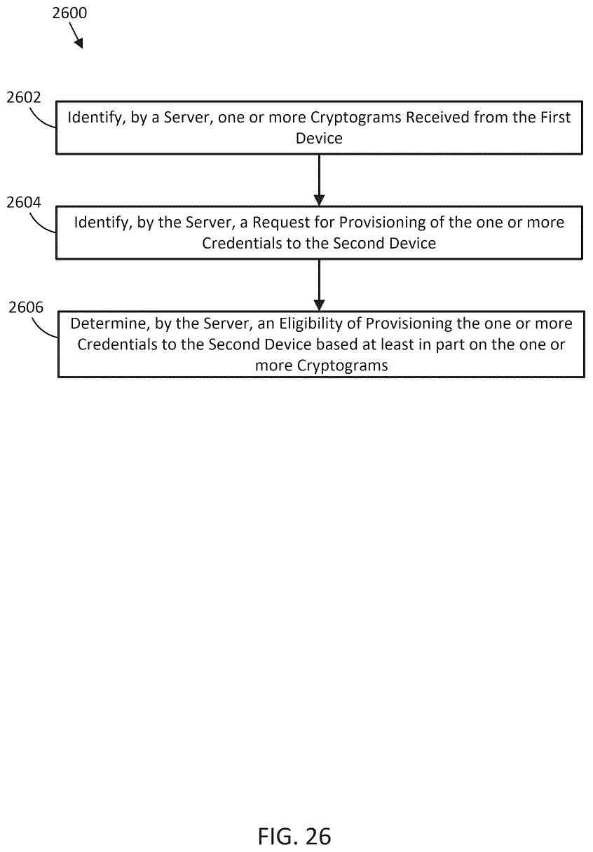

FIG. 26 illustrates an example procedure 2600 for migrating one or more credentials in accordance with some embodiments. The procedure 2600 may be performed by a server, such as the account server 210 (FIG. 2).

The procedure 2600 may include identifying, by a server, one or more cryptograms received from the first device in 2602, the one or more cryptograms corresponding to the one or more credentials.

The procedure 2600 may include identifying, by the server, a request for provisioning of the one or more credentials to the second device in 2604, the request received from the second device.

The procedure 2600 may include determining, by the server, an eligibility of provisioning the one or more credentials to the second device based at least in part on the one or more cryptograms in 2606.

In some embodiments, the procedure 2600 may include providing, by the server to the first device, provisioning information for provisioning the one or more credentials to the second device. The request for provisioning of the one or more credentials received from the second device may include at least a portion of the provisioning information. The eligibility of provisioning the one or more credentials to the second device may further be based at least in part on the provisioning information.

In some embodiments, the request for provisioning includes provisioning information. The procedure 2600 may include identifying, by the server, one or more signatures received from the first device. Further, the eligibility may be determined based at least in part on the provisioning information and the one or more signatures. In some of these embodiments, the one or more signatures may include a first signature and a second signature. The first signature may be generated based at least in part on a first certificate authentication secure domain (CASD) key corresponding to a first secure element of the first device. The second signature may be generated based at least in part on a second CASD key corresponding to a second secure element of the second device.

Any one or more of the operations in FIG. 26 may be performed in a different order than shown and/or one or more of the operations may be performed concurrently in embodiments. Further, it should be understood that one or more of the operations may be omitted from and/or one or more additional operations may be added to the procedure 2600 in other embodiments.

FIG. 27 illustrates an example architecture or environment 2700 configured to implement techniques described herein in accordance with some embodiments. The architecture 2700 includes a user device 2706 and a service provider computer 2702. In some examples, the example architecture 2700 may further be configured to enable the user device 2706 and the service provider computer 2702 to share information. In some examples, the devices may be connected via one or more networks 2708 (e.g., via Bluetooth, WiFi, the Internet). In some examples, the service provider computer 2702 may be configured to implement at least some of the techniques described herein with reference to the user device 2706 and vice versa.

In some examples, the networks 2708 may include any one or a combination of many different types of networks, such as cable networks, the Internet, wireless networks, cellular networks, satellite networks, other private and/or public networks, or any combination thereof. While the illustrated example represents the user device 2706 accessing the service provider computer 2702 via the networks 2708, the described techniques may equally apply in instances where the user device 2706 interacts with the service provider computer 2702 over a landline phone, via a kiosk, or in any other manner. It is also noted that the described techniques may apply in other client/server arrangements (e.g., set-top boxes), as well as in non-client/server arrangements (e.g., locally stored applications, peer-to-peer configurations).

As noted above, the user device 2706 may be any type of computing device such as, but not limited to, a mobile phone, a smartphone, a personal digital assistant (PDA), a laptop computer, a desktop computer, a thin-client device, a tablet computer, a wearable device such as a smart watch, an electronic device in a moveable vehicle or transport device, or the like. In some examples, the user device 2706 may be in communication with the service provider computer 2702 via the network 2708, or via other network connections.

In one illustrative configuration, the user device 2706 may include at least one memory 2714 and one or more processing units (or processor(s)) 2716. The processor(s) 2716 may be implemented as appropriate in hardware, computer-executable instructions, firmware, or combinations thereof. Computer-executable instructions or firmware implementations of the processor(s) 2716 may include computer-executable or machine-executable instructions written in any suitable programming language to perform the various functions described. The user device 2706 may also include geo-location devices (e.g., a global positioning system (GPS) device or the like) for providing and/or recording geographic location information associated with the user device 2706. In some examples, the processors 2716 may include a GPU and a CPU.

The memory 2714 may store program instructions that are loadable and executable on the processor(s) 2716, as well as data generated during the execution of these programs. Depending on the configuration and type of the user device 2706, the memory 2714 may be volatile (such as random access memory (RAM)) and/or non-volatile (such as read-only memory (ROM), flash memory). The user device 2706 may also include additional removable storage and/or non-removable storage 2726 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 2714 may include multiple different types of memory, such as static random access memory (SRAM), dynamic random access memory (DRAM), or ROM. While the volatile memory described herein may be referred to as RAM, any volatile memory that would not maintain data stored therein once unplugged from a host and/or power would be appropriate.

The memory 2714 and the additional storage 2726, both removable and non-removable, are all examples of non-transitory computer-readable storage media. For example, non-transitory computer-readable storage media may include volatile or non-volatile, removable or non-removable media implemented in any method or technology for storage of information such as computer-readable instructions, data structures, program modules, or other data. The memory 2714 and the additional storage 2726 are both examples of non-transitory computer-storage media. Additional types of computer-storage media that may be present in the user device 2706 may include, but are not limited to, phase-change RAM (PRAM), SRAM, DRAM, RAM, ROM, Electrically Erasable Programmable Read-Only Memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by the user device 2706. Combinations of any of the above should also be included within the scope of non-transitory computer-readable storage media. Alternatively, computer-readable communication media may include computer-readable instructions, program modules, or other data transmitted within a data signal, such as a carrier wave, or other transmission. However, as used herein, computer-readable storage media does not include computer-readable communication media.

The user device 2706 may also contain communications connection(s) 2728 that allow the user device 2706 to communicate with a data store, another computing device or server, user terminals, and/or other devices via the network 2708. The user device 2706 may also include I/O device(s) 2730, such as a keyboard, a mouse, a pen, a voice input device, a touch screen input device, a display, speakers, and a printer.

Turning to the contents of the memory 2714 in more detail, the memory 2714 may include an operating system 2712 and/or one or more application programs or services 2511 for implementing the features disclosed herein such as the receiver credential application 108 (FIG. 1), the receiver migration application 110 (FIG. 1), the source migration application 204 (FIG. 2), and/or the source credential application 206 (FIG. 2).

The service provider computer 2702 may also be any type of computing device such as, but not limited to, a collection of virtual or “cloud” computing resources, a remote server, a mobile phone, a smartphone, a PDA, a laptop computer, a desktop computer, a thin-client device, a tablet computer, a wearable device, a server computer, or a virtual machine instance. In some examples, the service provider computer 2702 may be in communication with the user device 2706 via the network 2708, or via other network connections.

In one illustrative configuration, the service provider computer 2702 may include at least one memory 2742 and one or more processing units (or processor(s)) 2744. The processor(s) 2744 may be implemented as appropriate in hardware, computer-executable instructions, firmware, or combinations thereof. Computer-executable instructions or firmware implementations of the processor(s) 2744 may include computer-executable or machine-executable instructions written in any suitable programming language to perform the various functions described.

The memory 2742 may store program instructions that are loadable and executable on the processor(s) 2744, as well as data generated during the execution of these programs. Depending on the configuration and type of service provider computer 2702, the memory 2742 may be volatile (such as RAM) and/or non-volatile (such as ROM and flash memory). The service provider computer 2702 may also include additional removable storage and/or non-removable storage 2746 including, but not limited to, magnetic storage, optical disks, and/or tape storage. The disk drives and their associated non-transitory computer-readable media may provide non-volatile storage of computer-readable instructions, data structures, program modules, and other data for the computing devices. In some examples, the memory 2742 may include multiple different types of memory, such as SRAM, DRAM, or ROM. While the volatile memory described herein may be referred to as RAM, any volatile memory that would not maintain data stored therein, once unplugged from a host and/or power, would be appropriate. The memory 2742 and the additional storage 2746, both removable and non-removable, are both additional examples of non-transitory computer-readable storage media.

The service provider computer 2702 may also contain communications connection(s) 2748 that allow the service provider computer 2702 to communicate with a data store, another computing device or server, user terminals, and/or other devices via the network 2708. The service provider computer 2702 may also include I/O device(s) 2750, such as a keyboard, a mouse, a pen, a voice input device, a touch input device, a display, speakers, and a printer.

Turning to the contents of the memory 2742 in more detail, the memory 2742 may include an operating system 2752 and/or one or more application programs 2741 or services for implementing the features disclosed herein.

FIG. 28 is a block diagram of an example computing device 2800 that can implement the features and processes described throughout this disclosure in accordance with some embodiments. The computing device 2800 is an example of the user device. The computing device 2800 can include a memory interface 2802, one or more data processors, image processors and/or central processing units 2804, and a peripherals interface 2806. The memory interface 2802, the one or more processors 2804 and/or the peripherals interface 2806 can be separate components or can be integrated in one or more integrated circuits. The various components in the computing device 2800 can be coupled by one or more communication buses or signal lines.

Sensors, devices, and subsystems can be coupled to the peripherals interface 2806 to facilitate multiple functionalities. For example, a motion sensor 2810, a light sensor 2812, and a proximity sensor 2814 can be coupled to the peripherals interface 2806 to facilitate orientation, lighting, and proximity functions. Other sensors 2816 can also be connected to the peripherals interface 2806, such as a global navigation satellite system (GNSS) (e.g., GPS receiver), a temperature sensor, a biometric sensor, magnetometer or other sensing device, to facilitate related functionalities.

A camera subsystem 2820 and an optical sensor 2822 (e.g., a charged coupled device (CCD) or a complementary metal-oxide semiconductor (CMOS) optical sensor) can be utilized to facilitate camera functions, such as recording photographs and video clips. The camera subsystem 2820 and the optical sensor 2822 can be used to collect images of a user to be used during authentication of a user (e.g., by performing facial recognition analysis).

Communication functions can be facilitated through one or more wireless communication subsystems 2824, which can include radio frequency receivers and transmitters and/or optical (e.g., infrared) receivers and transmitters. The specific design and implementation of the communication subsystem 2824 can depend on the communication network(s) over which the computing device 2800 is intended to operate. For example, the computing device 2800 can include communication subsystems 2824 designed to operate over a GSM network, a GPRS network, an EDGE network, a Wi-Fi or WiMax network, and a Bluetooth™ network.

An audio subsystem 2826 can be coupled to a speaker 2628 and a microphone 2830 to facilitate voice-enabled functions, such as speaker recognition, voice replication, digital recording, and telephony functions. The audio subsystem 2826 can be configured to facilitate processing voice commands, voice printing and voice authentication, for example.

The I/O subsystem 2840 can include a touch-surface controller 2842 and/or other input controller(s) 2844. The touch-surface controller 2842 can be coupled to a touch surface 2846. The touch surface 2846 and touch-surface controller 2842 can, for example, detect contact and movement or break thereof using any of a plurality of touch sensitivity technologies, including, but not limited to, capacitive, resistive, infrared, and surface acoustic wave technologies, as well as other proximity sensor arrays or other elements for determining one or more points of contact with the touch surface 2846.

The other input controller(s) 2844 can be coupled to other input/control devices 2848, such as one or more buttons, rocker switches, thumbwheel, infrared port, USB port, and/or a pointer device such as a stylus. The one or more buttons (not shown) can include an up/down button for volume control of the speaker 2828 and/or the microphone 2830.

In one implementation, a pressing of the button for a first duration can disengage a lock of the touch surface 2846; and a pressing of the button for a second duration that is longer than the first duration can turn power to the computing device 2800 on or off. Pressing the button for a third duration can activate a voice control, or voice command, module that enables the user to speak commands into the microphone 2830 to cause the device to execute the spoken command. The user can customize a functionality of one or more of the buttons. The touch surface 2846 can, for example, also be used to implement virtual or soft buttons and/or a keyboard.

In some examples, the computing device 2800 can present recorded audio and/or video files, such as MP3, AAC, and MPEG files. In some examples, the computing device 2800 can include the functionality of an MP3 player, such as an iPod™.

The memory interface 2802 can be coupled to memory 2850. The memory 2850 can include high-speed random-access memory and/or non-volatile memory, such as one or more magnetic disk storage devices, one or more optical storage devices, and/or flash memory (e.g., NAND, NOR). The memory 2850 can store an operating system 2852, such as Darwin, RTXC, LINUX, UNIX, OS X, WINDOWS, or an embedded operating system such as VxWorks.

The operating system 2852 can include instructions for handling basic system services and for performing hardware dependent tasks. In some examples, the operating system 2852 can be a kernel (e.g., UNIX kernel). In some examples, the operating system 2852 can include instructions for performing map data error correction. For example, operating system 2852 can implement the procedures described throughout this disclosure.

The memory 2850 can also store communication instructions 2854 to facilitate communication with one or more additional devices, one or more computers and/or one or more servers. The memory 2850 can include graphical user interface instructions 2856 to facilitate graphic user interface processing; sensor processing instructions 2858 to facilitate sensor-related processing and functions; phone instructions 2860 to facilitate phone-related processes and functions; electronic messaging instructions 2862 to facilitate electronic-messaging related processes and functions; web browsing instructions 2864 to facilitate web browsing-related processes and functions; media processing instructions 2866 to facilitate media processing-related processes and functions; GNSS/Navigation instructions 2868 to facilitate GNSS and navigation-related processes and instructions; and/or camera instructions 2870 to facilitate camera-related processes and functions.

The memory 2850 can store software instructions 2872 to facilitate other processes and functions, such as the procedure described in relation to the representation (FIG. 1), the procedure 2400 (FIG. 24), the procedure 2500 (FIG. 25), and/or the procedure 2600 (FIG. 26).

The memory 2850 can also store other software instructions 2874, such as web video instructions to facilitate web video-related processes and functions; and/or web shopping instructions to facilitate web shopping-related processes and functions. In some examples, the media processing instructions 2866 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 2850 can include additional instructions or fewer instructions. Furthermore, various functions of the computing device 2800 can be implemented in hardware and/or in software, including in one or more signal processing and/or application specific integrated circuits.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

In some embodiments, some or all of the operations described herein can be performed using an application executing on the user's device. Circuits, logic modules, processors, and/or other components may be configured to perform various operations described herein. Those skilled in the art will appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

As described above, one aspect of the present technology is the gathering, sharing, and use of data, including an authentication tag and data from which the tag is derived. The present disclosure contemplates that, in some instances, this gathered data may include personal information data that uniquely identifies or can be used to contact or locate a specific person. Such personal information data can include demographic data, location-based data, telephone numbers, email addresses, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to authenticate another device, and vice versa to control which device ranging operations may be performed. Further, other uses for personal information data that benefit the user are also contemplated by the present disclosure. For instance, health and fitness data may be shared to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence, different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of sharing content and performing ranging, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, users may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data at a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

In some examples, “circuitry” can refer to, be part of, or include hardware components such as an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, or the like. A “hardware resource” may refer to compute, storage, or network resources provided by physical hardware element(s). A “virtualized resource” may refer to compute, storage, or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, virtualized network function, or the like.

The term “information element” refers to a structural element containing one or more fields. The term “field” refers to individual contents of an information element, or a data element that contains content. An information element may include one or more additional information elements.

Although the present disclosure has been described with respect to specific embodiments, it will be appreciated that the disclosure is intended to cover all modifications and equivalents within the scope of the following claims.

All patents, patent applications, publications, and descriptions mentioned herein are incorporated by reference in their entirety for all purposes. None is admitted to be prior art.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure. The use of “or” is intended to mean an “inclusive or,” and not an “exclusive or,” unless specifically indicated to the contrary. Reference to a “first” component does not necessarily require that a second component be provided. Moreover, reference to a “first” or a “second” component does not limit the referenced component to a particular location unless expressly stated. The term “based on” is intended to mean “based at least in part on.”

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

The specific details of particular embodiments may be combined in any suitable manner or varied from those shown and described herein without departing from the spirit and scope of embodiments of the described techniques.

The above description of example embodiments of the described techniques has been presented for the purposes of illustration and description. It is not intended to be exhaustive or to limit the described techniques to the precise form described, and many modifications and variations are possible in light of the teaching above. The embodiments were chosen and described in order to best explain the principles of the described techniques and its practical applications to thereby enable others skilled in the art to best utilize the described techniques in various embodiments and with various modifications as are suited to the particular use contemplated.

All publications, patents, and patent applications cited herein are hereby incorporated by reference in their entirety for all purposes.

### EXAMPLES

In the following sections, further example embodiments are provided.

Example 1 may include a method of migrating one or more credentials to a first device from a second device, comprising identifying, by the first device, a request to migrate the one or more credentials from the second device to the first device, signing, by a secure element of the first device, a migration token corresponding to the one or more credentials, providing, by the first device to the second device, a migration request that includes the signed migration token, identifying, by the first device, provisioning information received from the second device, the provisioning information received from the second device based at least in part on the signed migration token, providing, by the first device to a server, at least a portion of the provisioning information, and receiving, by the first device, the one or more credentials based at least in part on the portion of the provisioning information.

Example 2 may include the method of example 1, wherein the migration token is signed with a certificate authority secure domain (CASD) key corresponding to the secure element, the CASD key being assigned to the secure element at production of the secure element.

Example 3 may include the method of example 1, further comprising providing, by the first device to the server, a request for provisioned credentials available for migration for an account associated with the first device, the provisioned credentials being provisioned to the second device, identifying, by the first device, an indication of one or more provisioned credentials available for migration, the one or more provisioned credentials from the provisioned credentials provisioned to the second device, and presenting, by the first device, a representation of the one or more provisioned credentials available for selection, wherein identifying the request to migrate the one or more credentials includes identifying a selection of the one or more credentials from the one or more provisioned credentials included in the presented representation.

Example 4 may include the method of example 3, wherein the indication of the one or more provisioned credentials includes one or more provisioned identifiers corresponding to the one or more provisioned credentials, and wherein the method further comprises determining one or more identifiers corresponding to the one or more credentials from the one or more provisioned identifiers based at least in part on the selection of the one or more credentials, wherein the migration request further includes the one or more identifiers.

Example 5 may include the method of example 1, further comprising establishing, by the first device, a session with the second device, and identifying, by the first device, a session identifier (ID) associated with the session, wherein the migration request further includes the session identifier, and wherein the provisioning information is received based at least in part on the session identifier.

Example 6 may include the method of example 1, wherein the provisioning information includes one or more provisioning tokens corresponding to the one or more credentials, wherein the one or more credentials are received based at least in part on the one or more provisioning tokens.

Example 7 may include the method of example 1, wherein the secure element is a first secure element, wherein the provisioning information includes a signed, hashed migration token corresponding to the migration token, wherein the signed, hashed migration token is signed with a certificate authority security domain (CASD) key corresponding to a second secure element of the second device, the CASD key being assigned to the second secure element at production of the second secure element.

Example 8 may include a user device, comprising memory configured to store instructions and one or more processors configured to execute the instructions to perform the method of any of examples 1-7.

Example 9 may include a non-transitory computer-readable medium comprising instructions stored thereon that, when executed by one or more processors of a user device, configure the user device to perform the method of any of claims 1-7.

Example 10 may include a method of migrating one or more credentials from a first device to a second device, comprising identifying, by the first device, a request to migrate the one or more credentials from the first device to the second device, the request including a migration token corresponding to the one or more credentials, signing, by a secure element of the first device, the migration token, providing, by the first device to a server, a provisioning request for provisioning of the one or more credentials, the provisioning request including the signed migration token, identifying, by the first device, provisioning information received from the server, the provisioning information for provisioning the one or more credentials to the second device, and providing, by the first device, at least a portion of the provisioning information to the second device.

Example 11 may include the method of example 10, wherein the signed migration token is signed with a certificate authority secure domain (CASD) key corresponding to the secure element, the CASD key being assigned to the secure element at production of the secure element.

Example 12 may include the method of example 10, wherein the secure element is first secure element, wherein the migration token identified in the request is signed with a certificate authority secure domain (CASD) key corresponding to a second secure element of the second device, the CASD key being assigned to the second secure element at production of the second secure element.

Example 13 may include the method of example 10, further comprising hashing, by the first device, the migration token to produce a hashed migration token, wherein signing the migration token includes signing the hashed migration token.

Example 14 may include the method of example 10, further comprising determining, by the first device, one or more authentication procedures corresponding to each of the one or more credentials, coalescing, by the first device, the one or more authentication procedures into an authentication procedure set for authentication for all of the one or more credentials, performing, by the first device, the authentication procedure set, and determining, by the first device, to sign the migration token based at least in part on successful authentication from the authentication procedure set.

Example 15 may include the method of example 14, wherein coalescing the one or more authentication procedures includes determining that an authentication procedure is to be performed for a first credential of the one or more credentials, and determining that the authentication procedure is to be performed for a second credential of the one or more credentials, wherein the authentication procedure set includes the authentication procedure, and performing the authentication procedure set includes performing the authentication procedure a single time for authentication for both the first credential and the second credential.

Example 16 may include the method of example 10, further comprising generating, by the secure element, one or more cryptograms corresponding to the one or more credentials, wherein the provisioning request further includes the one or more cryptograms, the one or more cryptograms to be utilized for validating migration of the one or more credentials from the first device to the second device.

Example 17 may include the method of example 16, further comprising signing, by the secure element, the one or more cryptograms with a certificate authority secure domain (CASD) key corresponding to the secure element, the CASD key being assigned to the secure element at production of the secure element.

Example 18 may include the method of example 16, wherein the generating the one or more cryptograms comprises generating one cryptogram for each of the one or more credentials.

Example 19 may include a method of facilitating migration of one or more credentials from a first device to a second device, comprising identifying, by a server, one or more cryptograms received from the first device, the one or more cryptograms corresponding to the one or more credentials, identifying, by the server, a request for provisioning of the one or more credentials to the second device, the request received from the second device, and determining, by the server, an eligibility of provisioning the one or more credentials to the second device based at least in part on the one or more cryptograms.

Example 20 may include the method of example 19, further comprising providing, by the server to the first device, provisioning information for provisioning the one or more credentials to the second device, wherein the request for provisioning of the one or more credentials received from the second device includes at least a portion of the provisioning information, and wherein the eligibility of provisioning the one or more credentials to the second device is further based at least in part on the provisioning information.

Example 21 may include the method of example 19, wherein the request for provisioning includes provisioning information, and wherein the method further comprises identifying, by the server, one or more signatures received from the first device, wherein the eligibility is determined based at least in part on the provisioning information and the one or more signatures.

Example 22 may include the method of example 21, wherein the one or more signatures includes a first signature and a second signature, the first signature generated based at least in part on a first certificate authentication secure domain (CASD) key corresponding to a first secure element of the first device, the second signature generated based at least in part on a second CASD key corresponding to a second secure element of the second device.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method of migrating one or more credentials to a first device from a second device, comprising:
identifying, by the first device, a request to migrate the one or more credentials from the second device to the first device;
signing, by a secure element of the first device, a migration token corresponding to the one or more credentials;
providing, by the first device to the second device, a migration request that includes the signed migration token;
identifying, by the first device, provisioning information received from the second device, the provisioning information received from the second device based at least in part on the signed migration token;
providing, by the first device to a server, at least a portion of the provisioning information; and
receiving, by the first device, the one or more credentials based at least in part on the portion of the provisioning information.

2. The method of claim 1, wherein the migration token is signed with a certificate authority secure domain (CASD) key corresponding to the secure element, the CASD key being assigned to the secure element at production of the secure element.

3. The method of claim 1, further comprising:
providing, by the first device to the server, a request for provisioned credentials available for migration for an account associated with the first device, the provisioned credentials being provisioned to the second device;
identifying, by the first device, an indication of one or more provisioned credentials available for migration, the one or more provisioned credentials from the provisioned credentials provisioned to the second device; and
presenting, by the first device, a representation of the one or more provisioned credentials available for selection, wherein identifying the request to migrate the one or more credentials includes identifying a selection of the one or more credentials from the one or more provisioned credentials included in the presented representation.

4. The method of claim 3, wherein the indication of the one or more provisioned credentials includes one or more provisioned identifiers corresponding to the one or more provisioned credentials, and wherein the method further comprises:
determining one or more identifiers corresponding to the one or more credentials from the one or more provisioned identifiers based at least in part on the selection of the one or more credentials, wherein the migration request further includes the one or more identifiers.

5. The method of claim 1, further comprising:
establishing, by the first device, a session with the second device; and
identifying, by the first device, a session identifier (ID) associated with the session, wherein the migration request further includes the session identifier, and wherein the provisioning information is received based at least in part on the session identifier.

6. The method of claim 1, wherein the provisioning information includes one or more provisioning tokens corresponding to the one or more credentials, wherein the one or more credentials are received based at least in part on the one or more provisioning tokens.

7. The method of claim 1, wherein the secure element is a first secure element, wherein the provisioning information includes a signed, hashed migration token corresponding to the migration token, wherein the signed, hashed migration token is signed with a certificate authority security domain (CASD) key corresponding to a second secure element of the second device, the CASD key being assigned to the second secure element at production of the second secure element.

8. A first device, comprising:
a secure element to:
sign a migration token corresponding to one or more credentials; and
one or more processors coupled to the secure element, the one or more processors configured to:
identify a request to migrate the one or more credentials from a second device to the first device;
provide, to the second device, a migration request that includes the signed migration token;
identify provisioning information received from the second device, the provisioning information received from the second device based at least in part on the signed migration token;
provide, to a server, at least a portion of the provisioning information; and
receive the one or more credentials based at least in part on the portion of the provisioning information.

9. The first device of claim 8, wherein the migration token is signed with a certificate authority secure domain (CASD) key corresponding to the secure element, the CASD key being assigned to the secure element at production of the secure element.

10. The first device of claim 8, wherein the one or more processors are further configured to:
provide, to the server, a request for provisioned credentials available for migration for an account associated with the first device, the provisioned credentials being provisioned to the second device;
identify an indication of one or more provisioned credentials available for migration, the one or more provisioned credentials from the provisioned credentials provisioned to the second device; and
present a representation of the one or more provisioned credentials available for selection, wherein to identify the request to migrate the one or more credentials includes to identify a selection of the one or more credentials from the one or more provisioned credentials included in the presented representation.

11. The first device of claim 10, wherein the indication of the one or more provisioned credentials includes one or more provisioned identifiers corresponding to the one or more provisioned credentials, and wherein the one or more processors are further configured to:
determine one or more identifiers corresponding to the one or more credentials from the one or more provisioned identifiers based at least in part on the selection of the one or more credentials, wherein the migration request further includes the one or more identifiers.

12. The first device of claim 8, wherein the one or more processors are further configured to:
establish a session with the second device; and
identify a session identifier (ID) associated with the session, wherein the migration request further includes the session identifier, and wherein the provisioning information is received based at least in part on the session identifier.

13. The first device of claim 8, wherein the provisioning information includes one or more provisioning tokens corresponding to the one or more credentials, wherein the one or more credentials are received based at least in part on the one or more provisioning tokens.

14. The first device of claim 8, wherein the secure element is a first secure element, wherein the provisioning information includes a signed, hashed migration token corresponding to the migration token, wherein the signed, hashed migration token is signed with a certificate authority security domain (CASD) key corresponding to a second secure element of the second device, the CASD key being assigned to the second secure element at production of the second secure element.

15. One or more non-transitory, computer-readable media having instructions that, when executed by one or more processors, cause a first device to:
identify a request to migrate one or more credentials from a second device to the first device;
sign, by a secure element of the first device, a migration token corresponding to the one or more credentials;
provide, to the second device, a migration request that includes the signed migration token;
identify provisioning information received from the second device, the provisioning information received from the second device based at least in part on the signed migration token;
provide, to a server, at least a portion of the provisioning information; and
receive the one or more credentials based at least in part on the portion of the provisioning information.

16. The one or more non-transitory, computer-readable media of claim 15, wherein the migration token is signed with a certificate authority secure domain (CASD) key corresponding to the secure element, the CASD key being assigned to the secure element at production of the secure element.

17. The one or more non-transitory, computer-readable media of claim 15, wherein the instructions, when executed by the one or more processors, further cause the first device to:
provide, to the server, a request for provisioned credentials available for migration for an account associated with the first device, the provisioned credentials being provisioned to the second device;
identify an indication of one or more provisioned credentials available for migration, the one or more provisioned credentials from the provisioned credentials provisioned to the second device; and
present a representation of the one or more provisioned credentials available for selection, wherein to identify the request to migrate the one or more credentials includes to identify a selection of the one or more credentials from the one or more provisioned credentials included in the presented representation.

18. The one or more non-transitory, computer-readable media of claim 17, wherein the indication of the one or more provisioned credentials includes one or more provisioned identifiers corresponding to the one or more provisioned credentials, and wherein the instructions, when executed by the one or more processors, further cause the first device to:
determine one or more identifiers corresponding to the one or more credentials from the one or more provisioned identifiers based at least in part on the selection of the one or more credentials, wherein the migration request further includes the one or more identifiers.

19. The one or more non-transitory, computer-readable media of claim 15, wherein the instructions, when executed by the one or more processors, further cause the first device to:
establish a session with the second device; and
identify a session identifier (ID) associated with the session, wherein the migration request further includes the session identifier, and wherein the provisioning information is received based at least in part on the session identifier.

20. The one or more non-transitory, computer-readable media of claim 15, wherein the provisioning information includes one or more provisioning tokens corresponding to the one or more credentials, wherein the one or more credentials are received based at least in part on the one or more provisioning tokens.
